(19) United States
(12) Patent Application Publication
(10) Pub. No.: US 2023/0214661 A1
(43) Pub. Date: Jul. 6, 2023

(54) COMPUTER SYSTEMS AND METHODS FOR LEARNING OPERATORS

(71) Applicant: The Trustees of the University of Pennsylvania, Philadelphia, PA (US)

(72) Inventors: Paris Georgios Perdikaris, Philadelphia, PA (US); George J. Pappas, Philadelphia, PA (US); Jacob Hugh Seidman, Philadelphia, PA (US); Georgios Kissas, Philadelphia, PA (US)

(21) Appl. No.: 18/092,888

(22) Filed: Jan. 3, 2023

Related U.S. Application Data
(60) Provisional application No. 63/296,067, filed on Jan. 3, 2022.

(51) Int. Cl. G06N 3/09

(52) U.S. Cl. CPC G06N 3/09

(57) ABSTRACT

Supervised operator learning is an emerging machine learning paradigm with applications to modeling the evolution maps of spatio-temporal dynamical systems and approximating general black-box relationships between functional data. We propose a novel operator learning method, LOCA (Learning Operators with Coupled Attention), motivated from the attention mechanism. The input functions are mapped to a finite set of features which are then averaged with attention weights that depend on the output query locations. By coupling these attention weights together with an integral transform, LOCA is able to explicitly learn correlations in the target output functions, enabling us to approximate nonlinear operators even when the number of output function measurements is very small.

### PRIORITY CLAIM

This application claims the benefit of U.S. Provisional Patent Application Ser. No. 63/296,067, filed Jan. 3, 2022, the disclosure of which is incorporated herein by reference in its entirety.

### GOVERNMENT INTEREST

This invention was made with government support under DE-AR0001201 and DE-SC0019116 awarded by the U.S. Department of Energy, FA9550-20-1-0060 and FA9550-19-1-0265 awarded by the Air Force Office of Scientific Research, and 2031985 awarded by the National Science Foundation. The government has certain rights in the invention.

### TECHNICAL FIELD

This specification relates generally to machine learning and more particularly to learning operators, e.g., with coupled attention.

### BACKGROUND

Supervised operator learning is an emerging learning paradigm with applications to modeling the evolution maps of spatio-temporal dynamical systems and approximating general black-box relationships between functional data.

The great success of modern deep learning lies in its ability to approximate maps between finite-dimensional vector spaces, as in computer vision (Santhanam et al., 2017), natural language processing (Vaswani et al., 2017), precision medicine (Rajkomar et al., 2019), bio-engineering (Kissas et al., 2020), and other data driven applications. A particularly successful class of such models are those built with the attention mechanism (Bandanau et al., 2015). For example, the Transformer is an attention-based architecture that has recently produced state of the art performance in natural language processing (Vaswani et al., 2017), computer vision (Dosovitskiy et al., 2020; Parmar et al., 2018), and audio signal analysis (Gong et al., 2021; Huang et al., 2018).

### BRIEF DESCRIPTION OF THE DRAWINGS

FIG. 1: An example sketch of operator learning for climate modeling: By solving an operator learning problem, we can approximate an in infinite-dimensional map between two functions of interest, and then predict one function using the other. For example, by providing the model with an input function, e.g. a surface air temperature field, we can predict an output function, e.g. the corresponding surface air pressure field.

FIG. 2: Schematic illustration of the Operator Kernel Attention method: The LOCA method builds a feature representation, v(u), of the input function and averages it with respect to ′(y). The transform D is first applied to the input function to produce a list of features, illustrated by disks in this case, and then a fully connected network is applied to construct v(u). The score function g is applied to the inputs together with the softmax function to produce the score vector ′i. The vi and ′i vectors are combined to evaluate the solution at the queried point E′(y)[v(u)] at the last step.

FIG. 3: A schematic visualization of the operator learning benchmarks considered in this work. Shown are the input/output function and a description of their physical meaning, as well as the operator that we learn for each example. In the Mechanical MNIST example, for visual clarity we do not present the map that the model is actually learning, which is the displacement in the vertical and the horizontal directions, but the position of each pixel under a specified displacement.

FIG. 4: (Data Efficiency) Relative L2 error boxplots for the solution of Darcy flow: We present the error statistics for the case of the Darcy flow in the form of boxplots for the case where we train on [1:5; :::; 100]% of the available output function measurements per example. We observe that our model presents fast convergence to a smaller median error than the other methods and the error spread is more concentrated around the median with fewer outliers.

FIG. 5: (Data Efficiency) Relative L2 error boxplots for the solution of the Shallow Water equations: We present the errors for each different predicted quantity of the Shallow Water equations. On the left, we present the quantity, which is the height of the water, and v1 and v2 which are the two components of the fluid velocity vector. We observe that LOCA achieves higher accuracy, and presents fewer outliers and more concentrated error spread compared its competitors.

FIG. 6: (Robustness) Relative L2 error boxplots for the Mechanical MNIST benchmark with noisy data: The left figure gives the distribution of errors for the displacement in the horizontal axis, v1, and the right figure gives the displacement in the vertical axis v2. For all cases we consider 7% of the whole training data set as labeled data used during training.

FIG. 7: (Robustness) Maximum relative L2 error boxplots for Mechanical MNIST with over random model initializations: The left and right subplots show the distribution of maximum errors over the testing data set for the horizontal and vertical displacements, respectively. We consider 7% of the available output function measurements for training and run the model for 10 different random initializations. We observe that our method shows better performance than the other methods for both parameters v1 and v2.

FIG. 8: (Generalization) Relative L2 error boxplots for the climate modeling experiment: We present the errors for the temperature prediction task on the testing data set. We consider 4% of the whole data set as labeled data used for training. We observe that our method performs better than the other methods both with respect to the median error and the error spread. FIG. 9: (Generalization) Antiderivative relative L2 error boxplots for out-of-distribution testing sets: We show the performance of all models when trained on increasingly out of distribution data sets from the testing set. We use all available output function measurements for training.

FIG. 10: (Generalization) Antiderivative relative L2 error boxplots given input functions with multiple length scales and amplitudes: We present samples of the input and output functions from the testing data set in the top left and right figures, respectively, as well as the test error boxplots for each method, bottom figure.

FIG. 11 is a flow diagram of an example method for learning an operator mapping an input function to an output function.

FIG. 12 illustrates the operator learning manifold hypothesis by showing an encoder, approximator, and decoder.

FIGS. 13A-C illustrate an antiderivative example.

FIGS. 14A-B present a visual comparison between linear and nonlinear decoders.

FIGS. 15A-C illustrate the advection equation example.

FIGS. 16A-B illustrate an example with propagation of free-surface waves.

FIG. 17 shows Table 1, a comparison of relative L² errors (in %) for the predicted output functions for the shallow water equations benchmark against existing state-of-the-art operator learning methods.

### DETAILED DESCRIPTION

The subject matter described herein relates to methods, systems, and computer readable media for learning operators. Examples of the methods, systems, and computer readable media are described below with reference to two papers. The first paper describes learning operators with coupled attention. The second paper describes nonlinear manifold decoders for operator learning.

The subject matter described herein can be implemented in software in combination with hardware and/or firmware. For example, the subject matter described herein can be implemented in software executed by a processor. In one example implementation, the subject matter described herein may be implemented using a computer readable medium having stored thereon computer executable instructions that when executed by the processor of a computer control the computer to perform steps.

Example computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

Learning Operators with Coupled Attention

1. Introduction

The great success of modern deep learning lies in its ability to approximate maps between finite-dimensional vector spaces, as in computer vision (Santhanam et al., 2017), natural language processing (Vaswani et al., 2017), precision medicine (Rajkomar et al., 2019), bio-engineering (Kissas et al., 2020), and other data driven applications. A particularly successful class of such models are those built with the attention mechanism (Bandanau et al., 2015). For example, the Transformer is an attention-based architecture that has recently produced state of the art performance in natural language processing (Vaswani et al., 2017), computer vision (Dosovitskiy et al., 2020; Parmar et al., 2018), and audio signal analysis (Gong et al., 2021; Huang et al., 2018).

Another active area of research is applying machine learning techniques to approximate operators between spaces of functions. These methods are particularly attractive for many problems in computational physics and engineering where the goal is to learn the functional response of a system from a functional input, such as an initial/boundary condition or forcing term. In the context of learning the response of systems governed by differential equations, these learned models can function as fast surrogates of traditional numerical solvers.

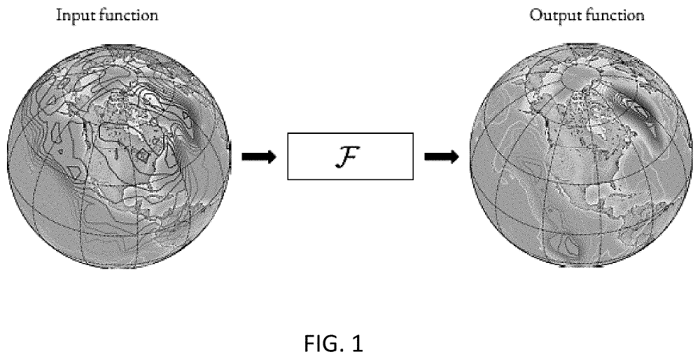

For example, in climate modelling one might wish to predict the pressure held over the earth from measurements of the surface air temperature field. The goal is then to learn an operator, F, between the space of temperature functions to the space of pressure functions (see FIG. 1). An initial attempt at solving this problem might be to take a regular grid of measurements over the earth for the input and output fields and formulate the problem as a (finite-dimensional) image to image regression task. While architectures such as convolutional neural networks may perform well under this setting, this approach can be somewhat limited. For instance, if we desired the value of the output at a query location outside of the training grid, an entirely new model would need to be built and tuned from scratch. This is a consequence of choosing to discretize the regression problem before building a model to solve it. If instead we formulate the problem and model at the level of the (infinite-dimensional) input and output function spaces and then made a choice of discretization, we can obtain methods that are more flexible with respect to the locations of the point-wise measurements.

Formulating models with functional data is the topic of Functional Data Analysis (FDA) (Ramsay, 1982; Ramsay and Dalzell, 1991), where parametric, semi-parametric or nonparametric methods operate on functions in in finite-dimensional vector spaces. A useful class of non-parametric approaches are Operator-Valued Kernel methods. These methods generalize the use of scalar-valued kernels for learning functions in a Reproducing Kernel Hilbert Space (RKHS) (Hastie et al., 2009) to RKHS's of operators. Kernel methods were thoroughly studied in the past (Hofmann et al., 2008; Shawe-Taylor et al., 2004) and have been successfully applied to nonlinear and high-dimensional problem settings (Takeda et al., 2007; Dou and Liang, 2020). Previous work has successfully extended this framework to learning operators between more general vector spaces as well (Micchelli and Pontil, 2005; Caponnetto et al., 2008; Kadri et al., 2010, 2016; Owhadi, 2020). This framework is particularly powerful as the inputs can be continuous or discrete, and the underlying vector spaces are typically only required to be normed and separable.

A parametric-based approach to operator learning was introduced in Chen and Chen (1995) where the authors proposed a method for learning non-linear operators based on a one-layer feed-forward neural network architecture. Moreover, the authors presented a universal approximation theorem which ensures that their architecture can approximate any continuous operator with arbitrary accuracy. Lu et al. (2019) gave an extension of this architecture, called DeepONet, built with multiple layer feed-forward neural networks, and demonstrated effectiveness in approximating the solution operators of various differential equations. In follow up work, error estimates were derived for some specific problem scenarios (Lanthaler et al., 2021), and several applications have been pursued (Cai et al., 2020; Di Leoni et al., 2021; Lin et al., 2021). An extension of the DeepONet was proposed by Wang et. al. (Wang et al., 2021c; Wang and Perdikaris, 2021; Wang et al., 2021b), where a regularization term is added to the loss function to enforce known physical constraints, enabling one to predict solutions of parametric differential equations, even in the absence of paired input-output training data.

Another parametric approach to operator learning is the Graph Neural Operator proposed by Li et al. (2020c), motivated by the solution form of linear partial differential equations (PDEs) and their Greens' functions. As an extension of this work, the authors also proposed a Graph Neural Operator architecture where a multi-pole method is used sample the spatial grid (Li et al., 2020b) allowing the kernel to learn in a non-local manner. In later published work, this framework has been extended to the case where the integral kernel is stationary, enabling one to efficiently compute the integral operator in the Fourier domain (Li et al., 2020a).

Both the Fourier Neural Operator and the DeepONet methods come with theoretical guarantees of universal approximation, meaning that under some assumptions these classes of models can approximate any continuous operator to arbitrary accuracy. Other parametric based models include a deep learning approach for directly approximating the Green's function of differential equations (Gin et al., 2021), a multi-wavelet approach for learning projections of an integral kernel operator to approximate the true operator and a random feature approach for learning the solution map of PDEs (Nelsen and Stuart, 2020), but no theoretical guarantees of the approximation power of these approaches are presented.

While some of the previously described operator learning methods can be seen as generalizations of deep learning architectures such as feed-forward and convolutional neural networks, here we are motivated by the success of the attention mechanism to propose a new operator learning framework. Specifically, we draw inspiration from the Badhanau attention mechanism (Bandanau et al., 2015), which first constructs a feature representation of the input and then averages these features with a distribution that depends on the argument of the output function to obtain its value. We will also use the connection between the attention mechanism and kernel methods (Tsai et al., 2019) to couple these distributions together in what we call a Kernel-Coupled Attention mechanism. This will allow our framework to explicitly model correlations within the output functions of the operator. Moreover, we prove that under certain assumptions the model satisfies a universal approximation property. The main contributions of this work can be summarized in the following points:
Methodological Novelty: We propose an operator learning framework inspired by the attention mechanism, operator approximation theory, and the Reproducing Kernel Hilbert Space (RKHS) literature. To this end, we introduce a novel Kernel-Coupling Attention mechanism to explicitly model correlations between the output functions' query locations.
Theoretical Guarantees: We prove that, under certain assumptions, the proposed framework can approximate any continuous operator with arbitrary accuracy.
Data Efficiency: By modelling correlations between output queries, our model can achieve high performance when trained with only a small fraction (6-12%) of the total available labeled data compared to competing methods.
Robustness: Compared to existing methods, our model demonstrates superior robustness with respect to noise corruption in the training and testing inputs, as well as randomness in the model initialization. Our model's performance is stable in that the errors on the test data set are consistently concentrated around the median with significantly fewer outliers compared to other methods.
Generalization: On a real data set of Earth surface air temperature and pressure measurements, our model is able to learn the functional relation between the two fields with high accuracy and extrapolate beyond the training data. On synthetic data we demonstrate that our model is able to generalize better than competing methods over increasingly out-of-distribution examples.

The paper is structured as follows. In Section 2 we introduce the supervised operator learning problem. In Section 3, we introduce the general form of the model and in following subsections present the construction of its different components. In Section 4 we prove theoretical results on the approximation power of this class of models. In Section 5 we present the specific architecture choices made for implementing our method in practice. Section 6 discusses the similarities and differences of our model with related operator learning approaches. In Section 7, we demonstrate the performance of the proposed methodology across different benchmarks in comparison to other state-of-the-art methods. In Section 8, we discuss our main findings, outline potential drawbacks of the proposed method, and highlight future directions emerging from this study.

### 2. Problem Formulation

We now provide a formal definition of the operator learning problem. Given [symbol] C [symbol] ^{dx}, we will refer to a point x ∈ [symbol] as an input location and a point y ∈ [symbol] as a query location. Denote by C(X, [symbol] ^{d}^{ᵤ} and C( [symbol] , [symbol] ^{d}^{ᵤ}) the spaces of continuous functions from [symbol] →^{d}^{ᵤ} and [symbol] → [symbol] ^{d}^{ᵤ}, respectively. We will refer to C( [symbol] , [symbol] ^{d}^{ᵤ}) as the space of input functions and C( [symbol] , [symbol] ^{d}^{ᵤ}) the space of output functions. For example, if we aim to learn the correspondence between a temperature field over the earth and the corresponding pressure field, u ∈C( [symbol] , [symbol] ) would represent the temperature field and s ∈C( [symbol] , [symbol] ) would be a pressure field, where X=Y represents the surface of the earth. With a data set of off input/output function pairs, we formulate the supervised operator learning problem as follows.

Problem 1 Given N pairs of input and output functions { [symbol] (x), [symbol] (y), [symbol] genernted by some ground truth operator [symbol] :C( [symbol] , [symbol] ^{d}^{ᵤ})→C(y, [symbol] ^{d}^{ₓ}) with [symbol] ∈C( [symbol] , [symbol] ^{d}^{ₓ}), and [symbol] ∈C( [symbol] , [symbol] ^{d}^{ₓ}), find an operator [symbol] :C( [symbol] , [symbol] ^{d}^{ₓ})→C(y, [symbol] ^{d}^{ₒ}), such that for [symbol] =1, . . . , N, [symbol] ( [symbol] )= [symbol] .

This problem also encompasses scenarios where more structure is known about the input/output functional relation. For example, u could represent the initial condition to a PDE and s the corresponding solution. In this case, G would correspond to the true solution operator and F would be an approximate surrogate model. Similarly, u could represent a forcing term in a dynamical system described by an ODE, and s the resulting integrated trajectory. In these two scenarios there do exist a suite of alternate methods to obtain the solution function s from the input u, but with an appropriate choice of architecture for F the approximate model can result in significant computational speedups and the ability to efficiently compute sensitivities with respect to the inputs. Note that while the domains X and Y need not be discrete sets, in practice we may only have access to the functions u′ and s′ evaluated at finitely many locations. However, we take the perspective that it is beneficial to formulate the model with continuously sampled input data, and consider the consequences of discretization at implementation time. As we shall see, this approach will allow us to construct a model that is able to learn operators over multiple output resolutions simultaneously.

### 3. Proposed Model

We will construct our model through the following two steps. Inspired by the attention mechanism (Bandanau et al., 2015), we will first define a class of models where the input functions u are lifted to a feature vector v(u) v(u)=∈ [symbol] ^{n×d}^{ₓ}. Each output location y ∈ y will define dₛ probability distributions φ(y)∈Πᵢ₌₁^{d}^{ₛ}=1Δₙ, where n is the the n-simplex. The forward pass of the model is then computed by averaging the rows of v(u) over the probability distributions φ(y).

Next, we augment this model by coupling the probability distributions φ(y) across different query points y ∈ Y. This is done by acting on a proposal score function g: [symbol] → [symbol] ^{n×d}, with a kernel integral operator. The form of the kernel determines the similarities between the resulting distributions. We empirically demonstrate that the coupled version of our model is more accurate compared to the uncoupled version when the number of output function evaluations per example is small.

### 3.1 The Attention Mechanism

The attention mechanism was first formulated in Bandanau et al. (2015) for use in language translation. The goal of this work was to translate an input sentence in a given language {u₁, . . . , u_{T}_{ᵤ}} to a sentence in another language {s₁, . . . , s_{T}_{ₛ}}. A context vector cᵢ was associated to each index of the output sentence, i ∈ {1, . . . , Tₛ}, and used to construct a probability distribution of the i-th word in the translated sentence, sᵢ. The attention mechanism is a way to construct these context vectors by averaging over features associated with the input in a way that depends on the output index i. In practice, the input sentence is first mapped to a collection of features {u₁, . . . , u_{T}_{ᵤ}}.

Next, depending on the input sentence and the location/index i in the output (translated) sentence, a discrete probability distribution {φi1, . . . , φiTᵤ} is formed over the input indices such that

$${φ}_{ij} \geq 0 , \qquad {\sum }_{j = 1}^{{T}_{u}} {φ}_{ij} = 1.$$

The context vector at index i is then computed as

$${c}_{i} = \qquad {\sum }_{j = 1}^{{T}_{u}} {φ}_{ij} {υ}_{j} .$$

If the words in the input sentence are represented by vectors in Rd, and the associated features and context vector are in RI, the attention mechanism can be represented by the following diagram.

$$\begin{matrix}[ {T}_{s} ] \times {ℝ}^{{T}_{u} \times d} & {⟶}^{Attn} {ℝ}^{l} \\ ( φ , υ ) ↓ & ↗ 𝔼 \\ {Δ}^{{T}_{u}} \times {ℝ}^{{T}_{u} \times l} & \end{matrix}$$

We will apply this mechanism to leam operators between function spaces by mapping an input function u to a finite set of features v(u) ∈ [symbol] ^{n×d}, and taking an average over these features with respect to ds distributions φ(y) ∈Πₖ₌₁^{d}^{ₛ}Δⁿthat depend on the query location y ∈ [symbol] for the output function. That is,

[symbol]

(u)(y):= [symbol] _{φ(y)}|v(u)|,

where v(u)∈ [symbol] ^{n×d}^{ₛ} is a function from y 2 Y to ds copies of the n-dimensional simplex Δⁿ, and [symbol] :Πₖ₌₁^{d}^{ₛ} Δⁿ× [symbol] ^{n×d}^{ₛ} → [symbol] ^{d}^{ₛ} is an expectation operator that takes (φ, v) [symbol] Σᵢ φᵢ ⊙vᵢ; where ⊙ denotes an element-wise product. This can be represented by the following diagram.

$$\begin{matrix}y \times C ( 𝒳 , {ℝ}^{{d}_{u}} ) & {⟶}^{ℱ} {ℝ}^{{d}_{u}} \\ ( φ , υ ) ↓ & ↗ 𝔼 \\ {\prod }_{k = 1}^{{d}_{x}} {Δ}^{n} \times {ℝ}^{n \times {d}_{x}} & \end{matrix}$$

In the next section, we will construct the function φ and provide a mechanism for enabling the coupling of its values across varying query locations y ∈ [symbol] . Later on, we will see that this allows the model to perform well even when trained on small numbers of output function measurements per input function.

### 3.2 Kernel-Coupled Attention Weights

In order to model correlations among the points of the output function we couple the probability distributions φ(y) across the different query locations y ∈ [symbol] . We first consider a proposal score function g:Y→ [symbol] ^{n×d}^{ₛ}. If we were to compose this function with a map into ds copies of the probability simplex Δⁿ, such as the softmax function σ: [symbol] ⁿ→Δⁿ applied to the rows of g(y), we would obtain the probability distributions

φ(y)=σ(g(y)).

The disadvantage of this formulation is that it solely relies on the form of the function g to capture relations between the distributions φ( y) across different y∈ Y. Instead, we introduce the Kernel-Coupled Attention (KCA) mechanism to model these relations by integrating the function g against a coupling kernel κ:Y×Y→ [symbol] . This results in the score function,

\tilde{g}(y)=∫_{y}κ(y,y′)g(y′)dy′, (1)

which can be normalized across its rows to form the probability distributions

φ(y)=σ(∫_{y}κ(y,y′)g(y′)dy′). (2)

The form of the kernel will determine how these distributions are coupled across y ∈ y.

For example, given a fixed y, the locations y′ where k(y, y′) is large will enforce similarity between the corresponding score functions \tilde{g}(y) and \tilde{g}(y′) . If k is a local kernel with a small bandwidth then points y and y0 will only be forced to have similar score functions if they are very close together.

### 3.3 Formulation of the Coupling Kernel

In this section we construct the coupling kernel that will be used to relate the query distributions as in (2). We first lift the points y ∈ Y via a nonlinear parameterized mapping qθ: [symbol] → [symbol] ^{l}. We then apply a universal kernel k: [symbol] ^{l}× [symbol] ^{l}→ [symbol] (Micchelli and Pontil, 2004) over the lifted space, such as the Gaussian RBF kernel,

k(z,z′)=γ exp (−β∥z−z′∥²), γ, β>0. (3)

Finally, we apply a normalization to the output of this kernel on the lifted points to create a similarity measure. The effect of the normalization is to maintain the relative scale of the proposal score function g. Overall, our kernel is defined as

$$κ ( y , {y}^{′} ) := \frac{k ( {q}_{0} ( y ) \cdot {q}_{0} ( {y}^{′} ) )}{{( {\int }_{y} k ( {q}_{0} ( y ) , {q}_{0} ( z ) ) dz )}^{1 / 2} {( {\int }_{y} k ( {q}_{0} ( {y}^{′} ) , {q}_{0} ( z ) ) dz )}^{1 / 2}} . \qquad ( 4 )$$

By tuning the parameters θ, β and γ in the functions q_{θ} and k, the kernel is able to learn the appropriate measures of similarity between the points in the output function domain Y.

### 3.4 Input Function Feature Encoding

The last architecture choice to be made concerns the functional form of the feature embedding v(u). Here, we construct the map v as a composition of two mappings. The first is a function

[symbol]

:C( [symbol] , [symbol] ^{d}^{ᵤ})→ [symbol] ^{d}, (5)

that maps an input function u to a finite-dimensional vector [symbol] (u)∈ [symbol] ^{d}. After creating he d-dimensional representation of the input function D(u), we pass this vector through a function f from a class of universal function approximators, such as fully connected neural networks. The composition of these two operations forms our feature representation of the input function,

v(u)=ƒo [symbol] (u). (6)

One example for the operator D is the image of the input function under d linear functionals on C( [symbol] : [symbol] ^{d}^{ᵤ}). For example, D could return the point-wise evaluation of the input function at fixed points. This would correspond to the action of d translated-functionals. The drawback of such an approach is that the model would not be able to accept measurements of the input function at any other locations. As a consequence the input resolution could never vary across forward passes of the model.

Alternatively, if we consider an orthonormal basis for L²( [symbol] ; [symbol] ^{d}^{ᵤ}) we could also have D be the projection onto the first d basis vectors. For example, if we use the basis of trigonometric polynomials the Fast Fourier Transform (FFT) (Cooley and Tukey, 1965) allows for efficient computation of these values and can be performed across varying grid resolutions. We could also consider the projection onto an orthogonal wavelet basis (Daubechies, 1988). In the case of complex valued coefficients for these basis functions, the range space dimension of D would be doubled to account for the real and imaginary part of these measurements.

### 3.5 Model Summary

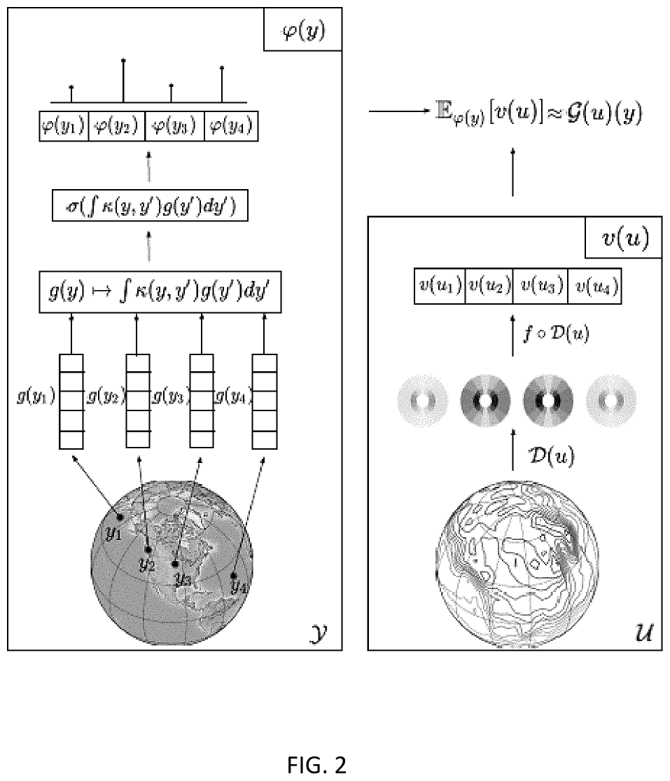

Overall, the forward pass of the proposed model is written as follows, see FIG. 2 for a visual representation.

$$ℱ ( u ) ( y ) = {𝔼}_{φ ( y )} [ υ ( u ) ] = {\sum }_{i = 1}^{n} σ ( {\int }_{y} κ ( y , {y}^{′} ) g ( {y}^{′} ) {dy}^{′} ) , ⊙ {υ}_{i} ( u ) . \qquad ( 7 )$$

In the next sections, we will perform analysis on this model. We will show that under certain architecture choices other models in the literature can be recovered and theoretical guarantees of universal approximation can be proven.

### 4. Theoretical Guarantees of Universality

In this section we give conditions under which the proposed model is universal. There exist multiple definitions of universality present in the literature, for example see (Sriperumbudur et al., 2011). To be clear, we formally state the definition we use below.

Definition 1 Given compact sets X ⊂ [symbol] ^{d}^{ₓ}, Y ⊂ [symbol] ^{d}^{ᵥ} and a compact set u ⊂ C( [symbol] , [symbol] ^{d}^{ₓ}) we say a class of operators [symbol] ∈ [symbol] :C( [symbol] , [symbol] ^{d}^{ₓ})→C( [symbol] , [symbol] ^{d}^{ₓ}) is universal if it is dense in the space of operators equipped with the supermun norm. In other words, for any contineous operator [symbol] :C( [symbol] , [symbol] ^{d}^{ₓ})→C( [symbol] , [symbol] ^{d}^{ₓ}) and any ∈>0, there exists [symbol] ∈ [symbol] such that

$${sup}_{u ∈ U} {sup}_{y ∈ Y} {‖ 𝒢 ( u ) ( y ) - ℱ ( u ) ( y ) ‖}_{{ℝ}^{{d}_{s}}}^{2} < ϵ .$$

To explore the universality properties of our model we note that if we remove the softmax normalization and the kernel coupling, the evaluation of the model can be written as

$$ℱ ( u ) ( y ) = {\sum }_{i = 1}^{n} {g}_{i} ( y ) ⊙ {v}_{i} ( u ) .$$

The universality of this class of models has been proven in Chen and Chen (1995) (when ds=1) and extended to deep architectures in Lu et al. (2019). We will show that our model with the softmax normalization and kernel coupling is universal by adding these components back one at a time. First, the following theorem shows that the normalization constraint φ(y)∈Πₖ₌₁^{d}^{ₓ} Δⁿ does not reduce the approximation power of this class of operators.

Theorem 2 if u ⊂ C( [symbol] , [symbol] ^{d}^{ₓ}) is a compact set of functions and [symbol] : [symbol] →C( [symbol] , [symbol] ^{d}^{ₓ}) is a continuous operator with [symbol] and [symbol] compact, then for every ∈>0 there exists n ∈ [symbol] . [0, 1]^{d}^{ₓ} and Σ₃₌₁ⁿ φy (y)=1_{d}, for all y ∈ [symbol] such that

$${sup}_{u ∈ U} {sup}_{y ∈ Y} {‖ 𝒢 ( u ) ( y ) - {𝔼}_{φ ( y )} [ v ( u ) ] ‖}_{{ℝ}^{{d}_{x}}}^{2} < ϵ .$$

Proof: The proof is given in Appendix B of the Appendix to the Specfication of the above-referenced provisional patent application.

It remains to show that the addition of the kernel coupling step for the functions also does not reduce the approximation power of this class of operators. By drawing a connection to the theory of Reproducing Kernel Hilbert Spaces (RKHS), we are able to state the sufficient conditions for this to be the case. The key insight is that, under appropriate conditions on the kernel, the image of the integral operator in (1) is dense in an RKHS [symbol] ₓ which itself is dense in C( [symbol] , [symbol] ⁿ). This allows (2) to approximate any continuous function φ: [symbol] →Πᵢ₌₁^{d}^{ₛ} Δⁿ and thus maintains the universality guarantee of Theorem 2.

Proposition 3 Let κ: [symbol] × [symbol] → [symbol] be a positive definite and Hermilian universal kernel with associnated BKHS [symbol] ₓ and define the integral operator

Tₓ:C(y, [symbol] ^{R})→C( [symbol] , [symbol] ^{R}), ∫ [symbol] ∫_{y}k(y,a)∫(x)dx.

If [symbol] ⊆C ( [symbol] , [symbol] ^{x}) is dense, then Tₓ ( [symbol] ) ⊂C( [symbol] , [symbol] ^{R}) is also dense.

Proof Note that im (Tₖ^{1/2})= [symbol] ₙ. (Paulsen and Raghupatit, 2016). Since h is universal, im(Tₖ^{1/2})= [symbol] ₖ ⊂C( [symbol] , [symbol] ^{R}) is dense. Thus, it suffices to show that Tₖ ( [symbol] ) is dense in im (Tₖ^{1/2}). We will make use of the following fact, which we state we state as a lemma for its repeated use.

Lemma 4. If ƒ:X→Y is a continuous map and A ⊂X is dense, then ƒ(A) is dense in im(ƒ).

By the above lemma, we have that Tₓ( [symbol] ) is dense in im(Tₖ) .Now we must show that im(Tₓ) ⊂ im(Tₖ^{1/2}) is dense as well. This again follows from the above lemma by noting that im(Tₖ)=Tₖ^{1/2}(im(Tₖ^{1/2})), and im(Tₖ^{1/2}) is dense in the domain of Tₖ^{1/2}.

We next show that the kernel defined in (4) can be made to satisfy Lemma 4.

Proposition 5 The kernel defined in (4) is positive definite and symmetric. Further, if q is injective, it defines a universal RKHS.

Proof The proof is provided in Appendix C of the Appendix to the Specification of the above-referenced provisional patent application.

Lastly, we present a result showing that a particular architecture choice for the feature encoder v also preserves universality.

Proposition 6 Let [symbol] _{d} ⊂ C( [symbol] ⁿ) be a set of functions dense in C( [symbol] ^{d}, [symbol] ⁿ), and {eₛ}ᵢ₌₁^{∝} a set of basis functions such that for some compact set [symbol] ⊆ C( [symbol] , [symbol] ^{d}^{ₓ}), Σᵢ₌₃^{∝} [symbol] u, e [symbol] L^{2ex} converges to u uniformly over [symbol] . Let [symbol] _{d}: [symbol] → [symbol] ^{d} denote the projection ones (e), . . . , e_{d}). Then for any continuous functional h; [symbol] → [symbol] ^{R}, and any ϵ>0, there exists d and ƒ ∈ [symbol] _{N} such that

$${sup}_{u ∈ U} ‖ h ( u ) - f ∘ {𝒟}_{d} ( u ) ‖ < ϵ .$$

Proof since [symbol] is compact, h uniformly continous. Hence, there exists δ>0 such that for any ∥u−v∥<δ, ∥h(v)−h(v)∥<ϵ/2. Define n_{d}:=Σᵢ₌₁^{d} [symbol] u, ϵ [symbol] u_{d}. By the uniform convergence of u_{d}→u over u ∈ [symbol] , there exists d such that for an u ∈ [symbol] , ∥u−u_{d}∥<δ. Thus, for all u ∈ [symbol] .

$$‖ h ( u ) - h ( {u}_{d} ) ‖ < \frac{ϵ}{2} .$$

If we define r; [symbol] ^{d}→C( [symbol] , [symbol] ^{d}^{ₓ}) as

$$r ( α ) := {{\sum }_{i = 1}}^{d} {α}_{i} {e}_{i} ,$$

we may write h(u_{d})=(h o r) ( [symbol] _{d}(u)). Now, note that h o r ∈ C( [symbol] ^{d}, [symbol] ⁿ), and recall that, by assumption, the function class [symbol] _{d} is dense in C( [symbol] ^{d}, [symbol] ⁿ). This means there exists ƒ ∈60 [symbol] _{d} such that ∥ƒ−h o r ∥<ϵ/2. Putting everthing together, we see that

∥h(u)−ƒo [symbol] _{d}(u)∥≤∥h(u )−h(u_{d})∥+∥(h o r)( [symbol] _{d}(u))−ƒo [symbol] _{d}(u)∥<ϵ.

For example, if our compact space of input functions U is contained in C¹( [symbol] , [symbol] ^{d}^{ᵤ}), and D is a projection onto a finite number of Fourier modes, the architecture proposed in equation (6) is expressive enough to approximate any functional from [symbol] → [symbol] , including those produced by the universality result stated in Theorem 2.

### 5. Implementation Aspects

To implement our method, it remains to make a choice of discretization for computing the integrals required for updating the KCA weights φ(y), as well as a choice for the input function feature encoding v(u). Here we address these architecture choices, and provide an overview of the proposed model's forward evaluation.

### 5.1 Computation of the Kernel Integrals

To compute the kernel coupled attention weights φ(y), we are required to evaluate integrals over the domain Y in (1) and (4). Adopting an unbiased Monte-Carlo estimator using P points y₁, . . . , y_{P} ∈ [symbol] , we can use the approximations

$${\int }_{y} κ ( y , {y}^{′} ) g ( {y}^{′} ) \approx \frac{vol ( y )}{P} {\sum }_{i = 1}^{P} κ ( y , {y}_{i} ) g ( {y}_{i} ) ,$$

for equation (1), and

$${\int }_{y} k ( q ( y ) , q ( 𝓏 ) ) d 𝓏 \approx \frac{vol ( y )}{P} {\sum }_{i = 1}^{P} k ( q ( y ) , q ( {y}_{i} ) ) ,$$

for use in equation (4). Note that due to the normalization in the vol(Y) term cancels out. In practice, we allow the query point y to be one of the points y₁, . . . , y_{P} used for the Monte-Carlo approximation.

When the domain Y is low dimensional, as in many physical problems, a Gauss-Legendre quadrature rule with weights wᵢ can provide an accurate and efficient alternative to Monte Carlo approximation. Using Q Gauss-Legendre nodes and weights, we can approximate the required integrals as

$${\int }_{y} κ ( y , {y}^{′} ) g ( {y}^{′} ) {dy}^{′} \approx {\sum }_{i = 1}^{Q} {w}_{i} κ ( y , {y}_{i}^{′} ) g ( {y}_{i}^{′} ) ,$$

for equation (1) and

$${\int }_{y} k ( q ( y ) , q ( 𝓏 ) ) d 𝓏 \approx {\sum }_{i = 1}^{Q} {w}_{i} k ( q ( y ) , q ( {𝓏}_{i} ) ) ,$$

for use in equation (4).

If we restrict the kernel to be translation invariant, there is another option for computing these integrals. As in Li et al. (2020a), we could take the Fourier transform of both and g, perform a point-wise multiplication in the frequency domain, followed by an inverse Fourier transform. However, while in theory the discrete Fourier transformation could be performed on arbitrarily spaced grids, the most available and computationally efficient implementations rely on equally spaced grids. We prefer to retain the flexibility of arbitrary sets of query points y and will therefore not pursue this alternate approach. In Section 7, we will switch between the Monte-Carlo and quadrature strategies depending on the problem at hand.

### 5.2 Positional Encoding of Output Query Locations

We additionally adopt the use of positional encodings, as they have been shown to improve the performance of attention mechanisms. For encoding the output query locations, we are motivated by the positional encoding in Vaswani et al. (2017), the harmonic feature expansion in Di Leoni et al. (2021), and the work of Wang and Liu (2019) for implementing the encoding to more than one dimensions. The positional encoding for a one dimensional query space is given by

e(y¹, 2j+(i−1)H)=cos (2^{j}πy¹) e(y¹, 2j+1+(i−1)H)=sin(2ⁱπy¹) (8)

where H the number of encoding coefficients, j=1, . . . , H/2, yⁱ the query coordinates in different spatial dimensions and 1=1, . . . , d_{y}. In contrast to Vaswani et al. (2017) we consider the physical position of the elements of the set y as the position to encode instead of their index position in a given list, as the index position in general does not have a physically meaningful interpretation.

### 5.3 Wavelet Scattering Networks as a Spectral Encoder

While projections onto an orthogonal basis allows us to derive a universality guarantee for the architecture, there can be some computational drawbacks. For example, it is known that the Fourier transform is not always robust to small deformations of the input (Mallat, 2012). More worrisome is the lack of robustness to noise corrupting the input function. In real world applications it will often be the case that our inputs are noisy, hence, in practice we are motivated to find an operator D with stronger continuity with respect to these small perturbations.

To address the aforementioned issues, we make use of the scattering transform (Bruna and Mallat, 2013), as an alternate form for the operator D. The scattering transform maps an input function to a sequence of values by alternating wavelet convolutions and complex modulus operations (Bruna and Mallat, 2013). To be precise, given a mother wavelet ψ and a finite discrete rotation group G, we denote the wavelet filter with parameter λ=(r,j)∈G× [symbol] as

ψ(u)=2^{d×j}ψ(2^{j}r⁻¹x).

Given a path of parameters p=(λ₁, . . . , λₘ), the scattering transform is defined by the operator

S[p]u=[∥]u*ψ_{λ}_{₁}|*ψ_{λ}_{₂}|. . . |*ψ_{λ}_{ₘ}|*ϕ(x), (9)

where ϕ(x) is a low pass filter. We allow the empty path ∅ as a valid argument of S with S[∅]u=u*ϕ. As shown in Bruna and Mallat (2013), this transform is Lipschitz continuous with respect to small deformations, while the modulus of the Fourier transform is not. This transform can be interpreted as a deep convolutional network with fixed filters and has been successfully applied in multiple machine learning contexts (Oyallon et al., 2017; Chang and Chen, 2015). Computationally, the transform returns functions of the form (9) sampled at points in their domain, which we denote by Ŝ[p](u).

By choosing d paths p₁, . . . , p_{d}, we may define the operator D as [symbol] (u)=(Ŝ[p₁](u), . . . , Ŝ[p_{d}](u))^{T}.

In practice, the number of paths used is determined by three parameters: J, the maximum scale over which we take a wavelet transform; L, the number of elements of the finite rotation group G, and m0, the maximum length of the paths p. While Proposition 6 does not necessarily apply to this form of D, we find that empirically this input encoding gives the best performance.

### 5.4 Loss Function and Training

The proposed model is trained by minimizing the empirical risk loss over the available training data pairs,

$$ℒ ( θ ) = \frac{1}{N} {\sum }_{i = 1}^{N} {\sum }_{ℓ = 1}^{p} {( {s}^{i} ( {y}_{ℓ}^{i} ) - {ℱ}_{θ} ( {u}^{i} ) ( {y}_{ℓ}^{i} ) )}^{2} , \qquad ( 10 )$$

where θ=(θ_{q}, θ_{f}, θ_{g}) denotes all trainable model parameters. This is the simplest choice that can be made for training the model. Other choices may include weighting the mean square error loss using the L1 norm of the ground truth output (Di Leoni et al., 2021; Wang et al., 2021b), or employing a relative L2 error loss (Li et al., 2020a). The minimization is performed via stochastic gradient descent updates, where the required gradients of the loss with respect to all the trainable model parameters can be conveniently computed via reverse-mode automatic differentiation.

### 5.5 Implementation Overview

In this section, we provide an overview in pseudo-code of the steps needed for implementing the LOCA method. The training data set is first processed by passing the input functions through a wavelet scattering networks (Bruna and Mallat, 2013), and applying a positional encoding to the query locations and the quadrature/Monte-Carlo integration points. The forward pass of the model is applied and gradients are computed for use with the ADAM optimizer (Kingma and Ba, 2014). After training, we make one-shot predictions for super resolution grids and we compute the relative L2 error between the ground truth output and the prediction.

Algorithm 1 Implementation summary of the LOCA method

```
Require:
  Input/output function pairs {uⁱ, sⁱ [symbol] .
  Query locations yⁱ for evaluating sⁱ.
  Quadrature points zⁱ.
Pre-processing:
  Apply transformation (6) on the input function to get û, the input
  features.
  Apply positional encoding (8) to query coordinates y, z, to get ŷ, \hat{z}.
  Choose the network architectures for functions q_{θq}, f_{θf}, and g_{θg}.
  Initialize the trainable parameters θ = (θ_{q}, θ_{f}, θ_{g})_{,} and choose a learning
  rate η.
Training:
  for i = 0 to 1 do
    Randomly select a mini-hatch of (û, ŷ, \hat{z}, s).
    Evaluste g_{θy} (q_{θy} (i)).
    Compute the Coupling Kernel κ(q_{θq} (ŷ), g_{θg} (\hat{z})) (4).
    Numerically approximate the KCA (1) and compute φ(y).
    Evaluate f_{θf} (û), as in Equation (6).
    Evaluate the expectation (7) and get s^{o}, the model prediction.
    Evaluate the training loss (10) and compute its gradients ∇_{θ} [symbol] (θᵢ).
    Update the trainable parameters via stochastic gradient descent:
    θᵢ₊₁ ← θ_{i-η}∇_{θ} [symbol]  (θᵢ).
  end for
```

### 6. Connections to Existing Operator Learning Methods

In this section, we provide some insight on the connections between our method and similar operator learning methods.

### 6.1 DeepONets

Note that if we identify our input feature map, v(u), with the DeepONet's branch network, and the location dependent probability distribution, with the DeepONet's trunk network, then the last step of both models is computed the same way. We can recover the DeepONet architecture from our model under three changes to the architecture in the forward evaluation. First, we would remove the normalization step in the construction of φ. Next, we remove the KCA mechanism that is applied to the candidate score function g (equivalently we may x the kernel to be

distributions along the diagonal). Finally, in the construction of the input feature map v(u), instead of the scattering transform we would act on the input with a collection of distributions at the fixed sensor locations. The resulting model is then identical in structure to the DeepONet model of Lu Lu et al. (2019).

### 6.2 Neural Operators

The connection between Neural Operators and DeepONets has been presented in Kovachki et al. (2021), where it is shown that a particular choice of neural operator architecture produces a DeepONet with an arbitrary trunk network and a branch network of a certain form. In particular, a Neural Operator layer has the form,

[symbol]

(z)=σ( [symbol] +∫_{Z} [symbol] (s, z) [symbol] (s)ds), (11)

where here is a point-wise nonlinearity. It is shown in Kovachki et al. (2021) that this architecture can be made to resemble a DeepONet under the following choices. First, set W(′)=0. Next, lift the input data to n tiled copies of itself and choose a kernel k that is separable in s and z. If the output of the layer is then projected back to the original dimension by summing the coordinates, the architecture resembles a DeepONet.

The correspondence between our model and DeepONets described above allows us to transitively connect our model to Neural Operators as well. We additionally note that the scattering transform component of our architecture can be viewed as a collection of multiple-layer Neural Operators with fixed weights. Returning to (11), when W(′)=0 for all ′, the forward pass of the architecture is a sequence of integral transforms interleaved with point-wise nonlinearities. Setting to be the complex modulus function and k(′) to be a wavelet filter we may write [symbol] =| [symbol] *τ/λ|.

When we compose L of these layers together, we recover (9) up to the application of the final low pass filter (again a linear convolution) v(L)=∥∥u*ψ_{λ}_{₁}|*ψ_{λ}_{₂}|. . . |*ψ_{λ}_{_{L}}|.

Thus, we may interpret the scattering transform as samples from a collection of Neural Operators with fixed weights. This connection between the scattering transform and convolutional neural architectures with fixed weights was noticed during the original formulation of the wavelet scattering transform by Bruna and Mallat (2013), and thus also extends to Neural Operators via the correspondence between Neural Operators and (finite-dimensional) convolutional neural networks (Kovachki et al., 2021).

### 6.3 Other Attention-Based Architectures

Here we compare our method with two other recently proposed attention-based operator learning architectures. The first is the Galerkin/Fourier Transformer (Cao, 2021). This method operates on a fixed input and output grid, and most similarly represents the original sequence-to-sequence Transformer architecture (Vaswani et al., 2017) with different choices of normalization. As in the original sequence-to-sequence architecture, the attention weights are applied across the indices (sensor locations) of the input sequence. By contrast, in our model the attention mechanism is applied to a finite-dimensional feature representation of the input that is not indexed by the input function domain. Additionally, our attention weights are themselves coupled over the domain Y via the KCA mechanism (2) as opposed to being defined over the input function domain in an uncoupled manner.

A continuous attention mechanism for operator learning was also proposed as a special case of Neural Operators in Kovachki et al. (2021).

There, it was noted that if the kernel in the Neural Operator was (up to a linear transformation) of the form

$$k ( v ( x ) , v ( y ) ) = {( \int exp ( \frac{( Av ( s ) , Bv ( y ) )}{\sqrt{m}} ) ds )}^{- 1} exp ( \frac{( Av ( x ) , Bv ( y ) )}{\sqrt{m}} ) ,$$

with A, B ∈ [symbol] ^{m×n}, then the corresponding Neural Operator layer can be interpreted as the continuous generalization of a transformer block. Further, upon discretization of the integral this recovers exactly the sequence-to-sequence discrete Transformer model.

The main difference of this kind of continuous transformer with our approach is again how the attention mechanism is applied to the inputs. The Neural Operator Transformer is similar to the Galerkin/Fourier Transformer in the sense that the attention mechanism is applied over the points of the input function itself, whereas our model first creates a different finite dimensional feature representation of the input function which the attention is applied to. We note that our model does make use of attention weights defined over a continuous domain, but it is the domain of the output functions Y as opposed to X. The coupling of the attention weights as a function of the output query in (2) with the kernel in (4) can be interpreted as a kind of un-normalized continuous self-attention mechanism where we view the query space Y as its own input space to generate the attention weights φ(y).

### 7. Results

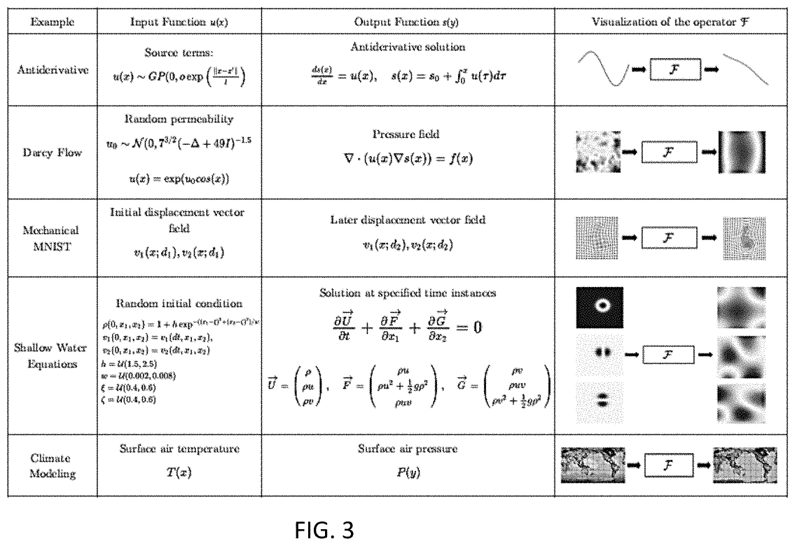

In this section we provide a comprehensive collection of experimental comparisons designed to assess the performance of the proposed LOCA model against two state of the art operator learning methods, the Fourier Neural Operator (FNO) (Li et al., 2020a) and the DeepONet (DON) (Lu et al., 2019). We will show that our method requires less labeled data than competing methods, is robust against noisy data and randomness in the model initialization, has a smaller spread of errors over testing data sets, and is able to successfully generalize in out-of-distribution testing scenarios. Evidence is provided for the following numerical experiments, see FIG. 3 for a visual description.

Antiderivative: Learning the antiderivative operator given multi-scale source terms.

Darcy Flow: Learning the solution operator of the Darcy partial dierential equation, which models the pressure of a fluid owing through a porous medium with random permeability.

Mechanical MNIST: Learning the mapping between the initial and final displacement of heterogeneous block materials undergoing equibiaxial extension.

Shallow Water Equations: Learning the solution operator for a partial differential equation describing the flow below a pressure surface in a fluid with reflecting boundary conditions.

Climate modeling: Learning the mapping from the air temperature field over the Earth's surface to the surface air pressure field, given sparse measurements.

For all experiments the training data sets will take the following form.

For each of the N input/output function pairs, (uⁱ, sⁱ), we will consider m discrete measurements of each input function, (uⁱ(x₁ⁱ), . . . , uⁱ(xₘⁱ)), and M available discrete measurements of each output function (Sⁱ(y₁ⁱ), . . . , Sⁱ(y_{M}ⁱ)), with the query locations [symbol] potentially varying over the data set. Out of the M available measurement points [symbol] for each output function sⁱ, we consider the effect of taking only P of these points for each input/output pair. For example, if we use 10% of labeled data, we set P=└M/10┘ and build a training data set where each example is of the form ({uⱼⁱ}ⱼ₌₁^{m}, {sⁱ [symbol] . We present details on the input and output data construction, as well as on the different problem formulations in Section D.5 of the Appendix in the Appendix to the Specification of the above-referenced provisional application, which is incorporated herein by reference.

In each scenario the errors are computed between both the models output and ground truth at full resolution. Throughout all benchmarks, we employ Gaussian Error Linear unit activation functions (GELU) (Hendrycks and Gimpel, 2016), and initialize all networks using the Glorot normal scheme (Glorot and Bengio, 2010). All networks are trained via mini-batch stochastic gradient descent using the Adam optimizer with default settings (Kingma and Ba, 2014). The detailed hyper-parameter settings, the associated number of parameters for all examples, the computational cost, and other training details are provided in Appendix D.2 of the Appendix to the Specification of the above-referenced provisional application. All code and data accompanying this manuscript will be made publicly available at https://github.com/PredictiveIntelligenceLab/LOCA.

### 7.1 Data Efficiency

In this section we investigate the performance of our model when the number of labeled output function points is small. In many applications labeled output function data can be scarce or costly to obtain. Therefore, it is desirable that an operator learning model is able to be successfully trained even without a large number of output function measurements. We investigate this property in the Darcy flow experiment by gradually increasing the percentage of labeled output function measurements used per input function example. Next, we compare the performance of all models for the Shallow Water benchmark in the small data regime. Lastly, we demonstrate that the proposed KCA weights provide additional training stability specifically in the small data regime. One important aspect of learning in the small data regime is the presence of outliers in the error statistics, which quantify the worst-case-scenario predictions. In each benchmark we present the following error statistics across the testing data set: the error spread around the median, and outliers outside the third quantile.

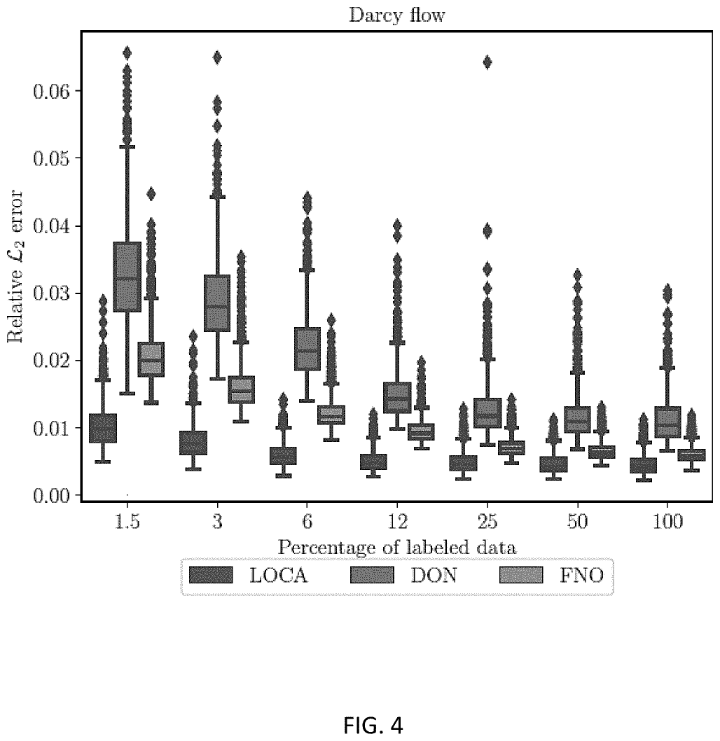

FIG. 4 shows the effect of varying the percentage of labeled output points used per training example in the Darcy flow prediction example. The box plot shows the distribution of errors over the test data set for each model. We see that the proposed LOCA model is able to achieve low prediction errors even with 1:5% of the available output function measurements per example. It also has a consistently smaller spread of errors with fewer outliers across the test data set in all scenarios. Moreover, when our model has access to 6% of the available output function measurements it achieves lower errors against both the DON and FNO trained with any percentage (up to 100%) of the total available labeled data.

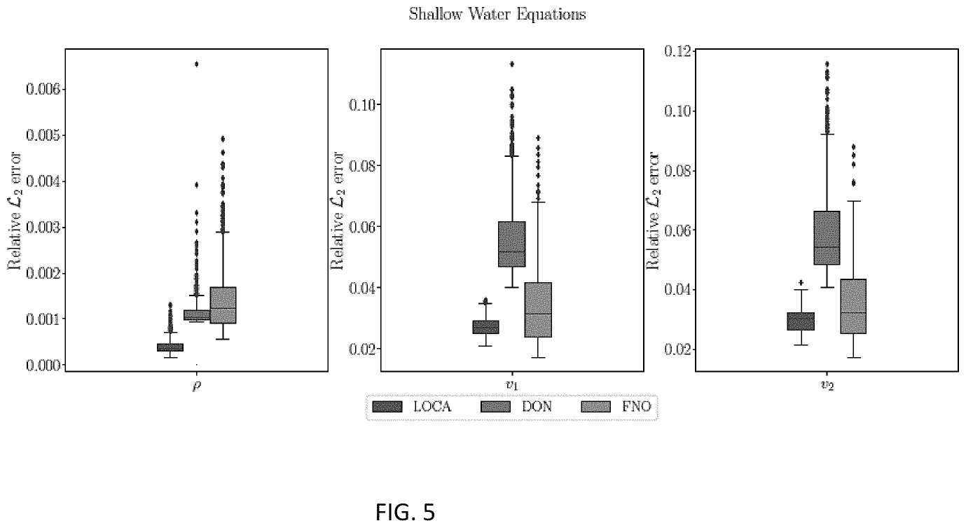

FIG. 5 shows the spread of errors across the test data set for the Shallow Water benchmark when the LOCA model is trained on 2:5% of the available labeled data per input-output function pair. We observe that our model outperforms DON and FNO in predicting the wave height, and provides similar errors to the FNO for the two velocity components, v1 and v2. Despite the fact that the two methods perform in a similar manner for the median error, LOCA consistently provides a much smaller standard deviation of errors across the test data set, as well as far fewer outliers.

We hypothesize that the ability of our model to successfully learn from fewer output function measurements stems from the KCA mechanism used in constructing ′(y). By coupling the values of the output function in this way, the model is able to learn the global behavior of the output functions with fewer example points. With the KCA step for φ included, the model still performs well in this small data regime.

### 7.2 Robustness

Operator learning can be a powerful tool for cases where we have access to clean simulation data for training, but wish to deploy the model on noisy experimental data. Alternatively we may have access to noisy data for training and want to make predictions on noisy data as well. We will quantify the ability of our model to handle noise in the data by measuring the percentage increase in mean error clean to noisy data scenarios. For all experiments in this section, we consider 7% of the available labeled data.

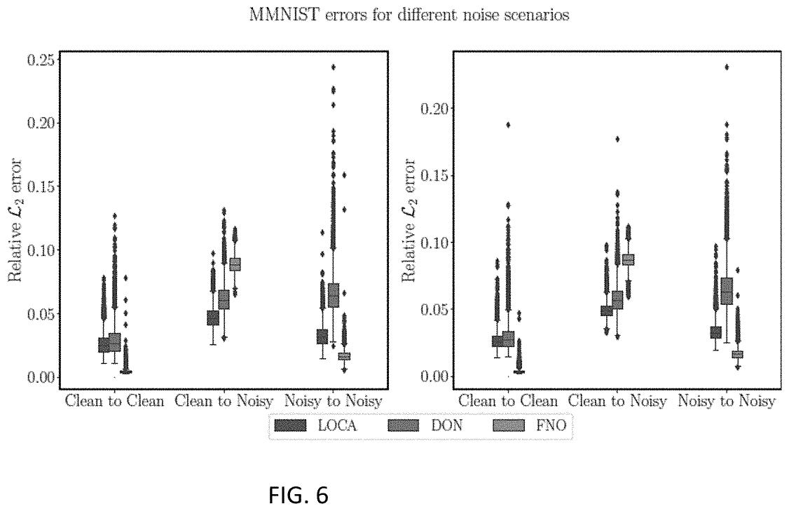

We use the Mechanical MNIST benchmark to investigate the robustness of our model with respect to noise in the training and testing data. We consider three scenarios: one where the training and the testing data sets are clean, one where the training data set is clean, but the output data set is corrupted Gaussian noise sampled from N(0; :15I), and one where both the input and the output data sets are corrupted by Gaussian noise sampled from N(0; :15I). In FIG. 6 we present the distribution of errors across the test data set for each noise scenario. We observe that for the case where both the training and the testing data are clean, the FNO achieves the best performance. In the scenario where the training data set is clean but the testing data set is noisy, we observe a percentage increase to the approximation error of all methods.

For the Clean to Noisy scenario the approximation error of the FNO method is increased by 1; 930% and 2; 238% for the displacement in the horizontal and vertical directions, respectively. For the DON method, the percentage increase is 112% and 96% for the displacement in the horizontal and vertical directions (labeled as v1 and v2), respectively. For the LOCA method the percentage increase is 80% and 85% for the displacement in the horizontal and vertical directions, respectively. For the Noisy to Noisy scenario the approximation error of the FNO method is increased by 280% and 347% for the displacement in the horizontal and vertical directions, respectively. For the DON method, the percentage increase is 128% and 120%, and for LOCA is only 26% and 25% for each displacement component, respectively.

We observe that even though the FNO is very accurate for the case where both training and test data sets are clean, a random perturbation of the test data set can cause a huge decrease in accuracy. On the other hand, even though the DON method presents similar accuracy as our model in the clean to clean case, the standard deviation of the error as well as its robustness to noise are inferior. LOCA is clearly superior in the case where the testing data are corrupted with Gaussian noise. We again emphasise that the metric in which we assess the performance is not which method has the lowest relative prediction error, but which method presents the smallest percentage increase in the error when noise exists in testing (and training in the case of Noisy to Noisy) data compared to the case where there exist no noise.

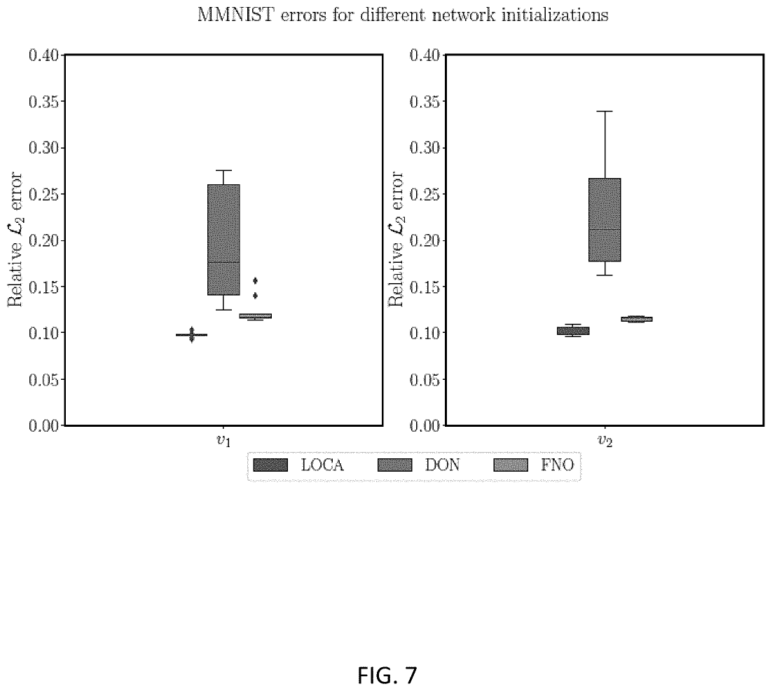

Next, we examine the variability of the models' performance with respect to the random initialization of the network parameters. We consider the Mechanical MNIST benchmark where the input data is clean but the output data contain noise. We train each model 10 times with different random seeds for initialization and record the maximum error in each case. In FIG. 7 we present the distribution of maximum prediction errors under different random seeds for the displacement in horizontal and vertical directions, respectively. We observe that LOCA displays a smaller spread of error for the case of displacement in the horizontal direction, v1, and similar performance to the FNO for the case of displacement in the vertical direction, v2.

### 7.3 Generalization

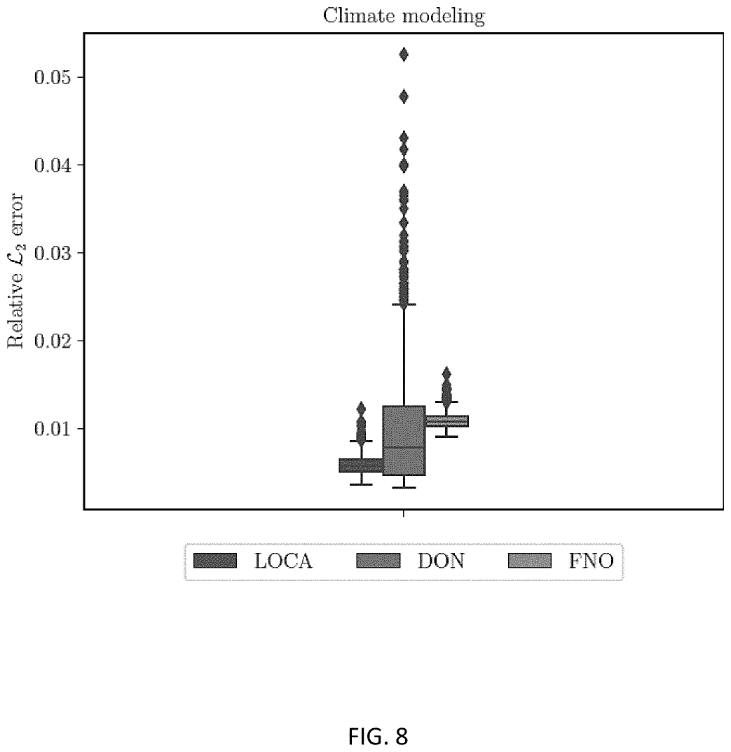

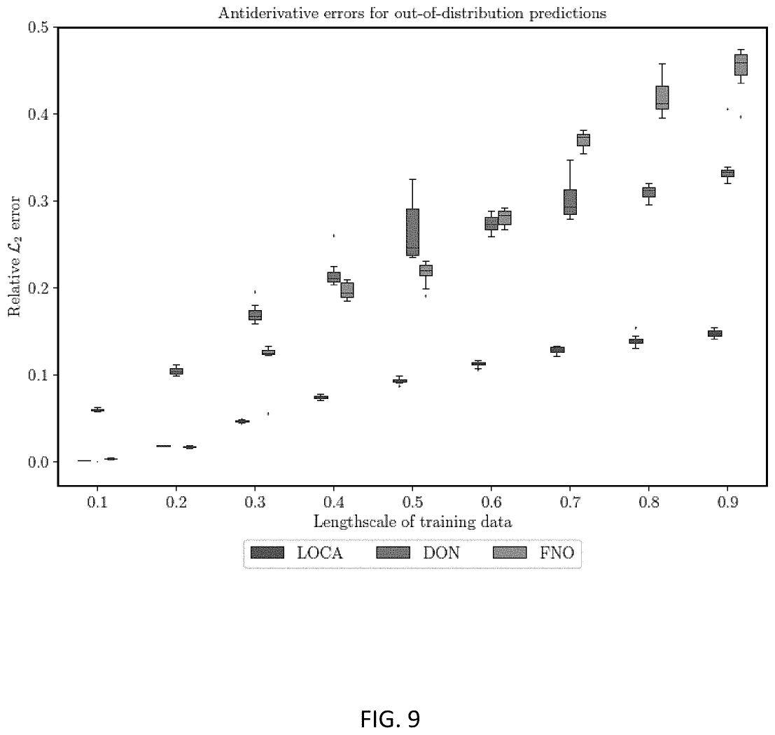

The ultimate goal of data-driven methods is to perform well outside of the data set they are trained on. This ability to generalize is essential for these models to be practically useful. In this section we investigate the ability of our model to generalize in three scenarios. We first consider an extrapolation problem where we predict the daily Earth surface air pressure from the daily surface air temperature. Our training data set consists of temperature and pressure measurements from 2000 to 2005 and our testing data set consists of measurements from 2005 to 2010. In FIG. 8, we present the results for the extrapolation problem when considering 4% of the available pressure measurements each day for training. We observe that our method achieves the lowest error rates while also maintaining a small spread of these errors across the testing data set. While the DON method achieves a competitive performance with respect to the median error, the error spread is larger than both LOCA and FNO with many outliers.

Next, we examine the performance of our model under a distribution shift of the testing data. The goal of the experiment is to learn the antiderivatve operator where the training and testing data sets are sampled from a Gaussian process. We fix the length-scale of the testing distribution at 0:1 and examine the effect of training over 9 different data sets with length-scales ranging from 0:1 to 0:9. In FIG. 9, we present the error on the testing data set after being trained on each different training data set. The error for each testing input is averaged over 10 random network initialization. We observe that while the LOCA and FNO methods present a similar error for the first two cases, the FNO error is rapidly increasing. On the other hand, the DON method while presenting a larger error at first, eventually performs better than the FNO as the training length-scale increases. We find that LOCA outperforms its competitors for all cases.

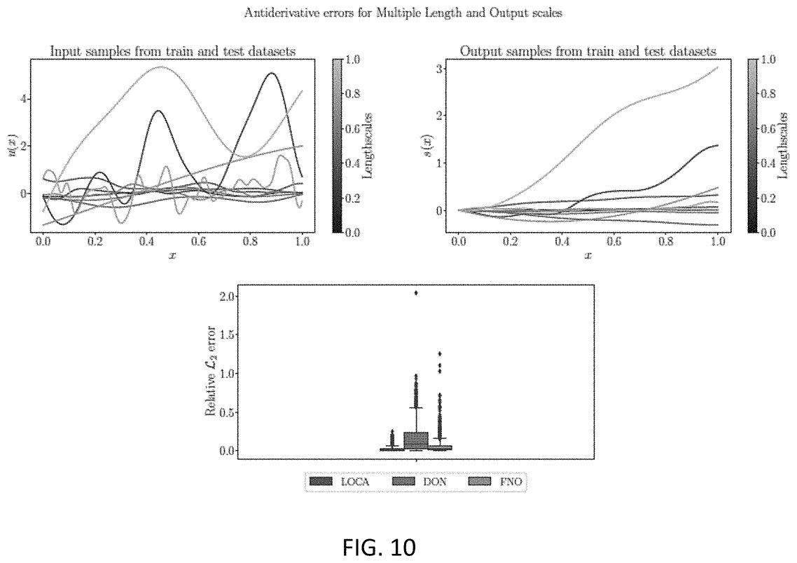

Lastly, we examine the performance of the three models when the training and testing data set both contain a wide range of scale and frequency behaviors. We consider this set-up as a toy model for a multi-task learning scenario and we want to explore the generalization capabilities of our model for this case. We construct a training and testing data set by sampling inputs from a Gaussian process where the length-scale and amplitude are chosen over ranges of 2 and 4 orders of magnitude, respectively. In FIG. 10, we present samples from the input distribution, the corresponding output functions, and the distribution of errors on the testing data set. We observe that our method is more accurate and the error spread is smaller than DON and Fourier Neural Operators. While the FNO method shows a median that is close to the LOCA model, there exist many outliers that reach very high error values.

### 8. Discussion

This work proposes a novel operator learning framework with approximation theoretic guarantees. Drawing inspiration from the Bandanau attention mechanism, the model is constructed by averaging a feature embedding of an input function over probability distributions that depend on the corresponding output function's query locations. To construct these probability distributions we introduce a twist on the classic notion of the attention mechanism called Kernel-Coupled Attention. Instead of normalizing a single proposal score functioning defined over the query domain Y, the Kernel Coupled Attention mechanism couples the score function across point in Y by integrating against a similarity kernel. Thus, the Kernel Coupled Attention mechanism is able to model correlations between different query scores explicitly instead of relying on the score function g to learn these relations alone. We hypothesize, and support with experiments, that this property allows the model to learn very efficiently using a small fraction of labeled data. In order to have a feature encoder that is robust to small deformations and noise in the input, we employ a multi-resolution feature extraction method based on the wavelet scattering transform Bruna and Mallat (2013). We empirically show that this is indeed a property of our model.

Our experiments additionally show that the model is able to generalize across varying distributions of functional inputs, and is able to extrapolate on a functional regression task with global climate data.

Another potential extension of our framework is to take the output of our model as the input function of another LOCA module and thus make a layered version of the architecture.

Lastly, recall that the output of our model corresponds to the context vector generated in the Bandanau attention. In the align and translate model of Bandanau et al. (2015) this context vector is used to construct a distribution over possible values at the output location. By using the output of our model as a context vector in a similar architecture, we can create a probabilistic model for the potential values of the output function, therefore providing a way to quantify the uncertainty associated with the predictions of our model.

A main application of operator learning methods is for PDEs, where they are used as surrogates for traditional numerical solvers. Since the forward pass of these kinds of models is significantly faster than classic numerical methods, the solution of a PDE under many different initial conditions can be obtained quickly. This is incredibly useful in design and optimal control problems where many inputs must be tested to produce a desired outcome from a physical system. As well as approaching these kinds of problems by sampling inputs, the quick evaluation of sensitivities with respect to the inputs (via automatic differentiation) allows the implementation of gradient based optimization methods for design of output as well. Alternate methods for computing sensitivities typically rely on solving an associated adjoint system with a numerical solver while a well-trained operator learning architecture can compute these sensitivities in fractions of the time. Therefore, we expect that successful application of operator learning methods to predict the output of physical systems from control inputs can have a significant impact in the design of optimal inputs and controls. Some preliminary work in this direction has been explored in Wang et al. (2021a).

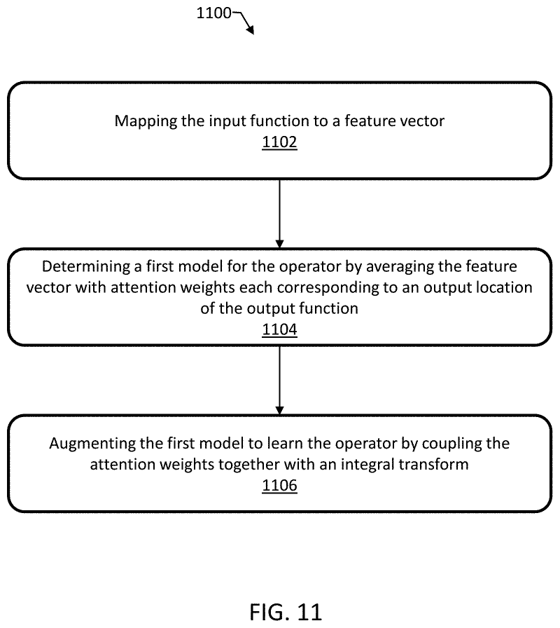

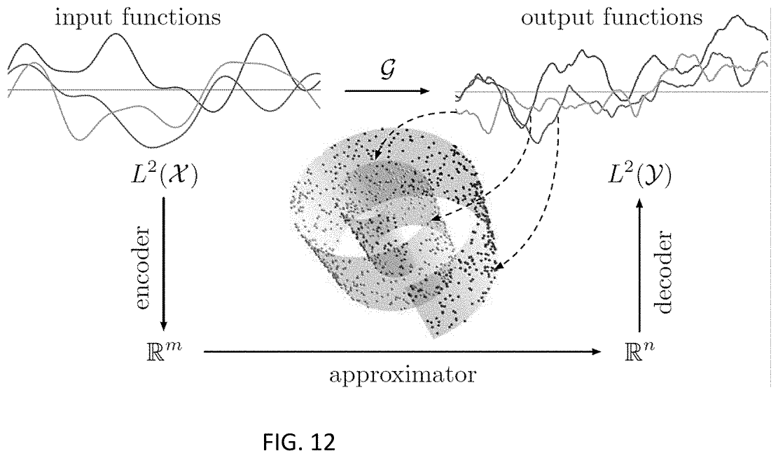

FIG. 11 is a flow diagram of an example method 1100 for learning an operator mapping an input function to an output function. The input function or the output function or both can be continuous functions.

The method 1100 can be performed by a computer system having one or more processors and memory storing instructions for the processors. An operator trainer can be configured as software executed on the computer system to perform the method 1100.

The method 1100 includes mapping the input function to a feature vector (1102). Mapping the input function to a feature vector can include using a wavelet scattering transform as a spectral encoder of the input function.

The method 1100 includes determining a first model for the operator by averaging the feature vector with attention weights each corresponding to an output location of the output function (1104). In some examples, each output location defines one or more probability distributions, and determining the first model includes averaging rows of the feature vector over the probability distributions.

The method 1100 includes augmenting the first model to learn the operator by coupling the attention weights together with an integral transform (1106). Coupling the attention weights together with an integral transform can include coupling the attention weights together with a kernel integral operator. Coupling the attention weights together with an integral transform can include integrating a proposal score function against a coupling kernel. Coupling the attention weights together with an integral transform can include tuning one or more parameters of a coupling kernel.

The disclosure of each of the following references is incorporated herein by reference in its entirety.

### References

Martin Alneas, Jan Blechta, Johan Hake, August Johansson, Benjamin Kehlet, Anders Logg, Chris Richardson, Johannes Ring, Marie E Rognes, and Garth N Wells. The FEniCS project version 1.5. Archive of Numerical Software, 3(100), 2015.

Mathieu Andreux, Tom'as Angles, Georgios Exarchakis, Roberto Leonarduzzi, Gaspar Rochette, Louis Thiry, John Zarka, St'ephane Mallat, Joakim And'en, Eugene Belilovsky, et al. Kymatio: Scattering transforms in python. J. Mach. Learn. Res., 21(60):1-6, 2020.

Dzmitry Bandanau, Kyunghyun Cho, and Yoshua Bengio. Neural machine translation by jointly learning to align and translate. In Yoshua Bengio and Yann LeCun, editors, 3rd International Conference on Learning Representations, ICLR 2015, San Diego, Calif., USA, May 7-9, 2015, Conference Track Proceedings, 2015. URL http://arxiv.org/abs/1409. 0473.

Jacob Bear. Dynamics of fluids in porous media. Courier Corporation, 2013.

James Bradbury, Roy Frostig, Peter Hawkins, Matthew James Johnson, Chris Leary, Dougal Maclaurin, George Necula, Adam Paszke, Jake VanderPlas, Skye Wanderman-Milne, and Qiao Zhang. JAX: composable transformations of Python+NumPy programs, 2018. URL http://github.com/google/jax.

Joan Bruna and St'ephane Mallat. Invariant scattering convolution networks. IEEE transactions on pattern analysis and machine intelligence, 35(8):1872-1886, 2013.

Shengze Cai, Zhicheng Wang, Lu Lu, Tamer A Zaki, and George Em Karniadakis. Deepm&mnet: Inferring the electroconvection multiphysics fields based on operator approximation by neural networks. arXiv preprint arXiv.2009.12935, 2020.

Shuhao Cao. Choose a transformer: Fourier or Galerkin. arXiv preprint arXiv2105.14995, 2021.

Andrea Caponnetto, Charles A Micchelli, Massimiliano Pontil, and Yiming Ying. Universal multi-task kernels. The Journal of Machine Learning Research, 9:1615-1646, 2008.

Kuang-Yu Chang and Chu-Song Chen. A learning framework for age rank estimation based on face images with scattering transform. IEEE Transactions on Image Processing, 24(3): 785-798, 2015.

Tianping Chen and Hong Chen, Universal approximation to nonlinear operators by neural networks with arbitrary activation functions and its application to dynamical systems. IEEE Transactions on Neural Networks, 6(4):911-917,1995.

Krzysztof Choromanski, Valerii Likhosherstov, David Dohan, Xingyou Song, Andreea Gane, Tamas Sarlos, Peter Hawkins, Jared Davis, Afroz Mohiuddin, Lukasz Kaiser, et al. Rethinking attention with performers. arXiv preprint arXiv2009.14794, 2020.

Andreas Christmann and Ingo Steinwart. Universal kernels on non-standard input spaces. In Advances in neural information processing systems, pages 406-414. Citeseer, 2010.

James W Cooley and John W Tukey. An algorithm for the machine calculation of complex Fourier series. Mathematics of computation, 19(90):297-301, 1965.

I Daubechies. Orthogonal bases of compactly supported wavelets, communications on pure and applied, 1988.

P Clark Di Leoni, Lu Lu, Charles Meneveau, George Karniadakis, and Tamer A Zaki. Deeponet prediction of linear instability waves in high-speed boundary layers. arXiv preprint arXiv2105.08697, 2021.

Alexey Dosovitskiy, Lucas Beyer, Alexander Kolesnikov, Dirk Weissenborn, Xiaohua Zhai,

Thomas Unterthiner, Mostafa Dehghani, Matthias Minderer, Georg Heigold, Sylvain Golly, et al. An image is worth 16×16 words: Transformers for image recognition at scale. arXiv preprint arXiv:2010.11929, 2020.

Xialiang Dou and Tengyuan Liang. Training neural networks as learning data-adaptive kernels: Provable representation and approximation benefits. Journal of the American Statistical Association, pages 1-14, 2020.

Craig R Gin, Daniel E Shea, Steven L Brunton, and J Nathan Kutz. Deepgreen: Deep learning of Green's functions for nonlinear boundary value problems. Scientific reports, 11 (1):1-14, 2021.

Xavier Glorot and Yoshua Bengio. Understanding the difficulty of training deep feedforward neural networks. In Proceedings of the thirteenth international conference on artificial intelligence and statistics, pages 249-256. JMLR Workshop and Conference Proceedings, 2010.

Yuan Gong, Yu-An Chung, and James Glass. Ast: Audio spectrogram transformer. arXiv preprint arXiv:2104.01778, 2021.

Charles R Harris, K Jarrod Millman, St'efan J van der Walt, Ralf Gommers, Pauli Virtanen, David Cournapeau, Eric Wieser, Julian Taylor, Sebastian Berg, Nathaniel J Smith, et al. Array programming with numpy. Nature, 585(7825):357-362, 2020.

Trevor Hastie, Robert Tibshirani, and Jerome Friedman. The elements of statistical learning: data mining, inference, and prediction. Springer Science & Business Media, 2009.

Dan Hendrycks and Kevin Gimpel. Gaussian error linear units (gelus). arXiv preprint arXiv:1606.08415, 2016.

Thomas Hofmann, Bernhard Schölkopf, and Alexander J Smola. Kernel methods in machine learning. The annals of statistics, pages 1171-1220, 2008.

Cheng-Zhi Anna Huang, Ashish Vaswani, Jakob Uszkoreit, Noam Shazeer, Ian Simon, Curtis Hawthorne, Andrew M Dai, Matthew D Hoffman, Monica Dinculescu, and Douglas Eck. Music transformer. arXiv preprint arXiv:1809.04281, 2018.

John D Hunter. Matplotlib: A 2D graphics environment. IEEE Annals of the History of Computing, 9(03):90-95,2007.

Hachem Kadri, Emmanuel Duflos, Philippe Preux, St'ephane Canu, and Manuel Davy.

Nonlinear functional regression: a functional RKHS approach. In Proceedings of the Thirteenth International Conference on Artificial Intelligence and Statistics, pages 374-380. JMLR Workshop and Conference Proceedings, 2010.

Hachem Kadri, Emmanuel Duflos, Philippe Preux, S'ephane Canu, Alain Rakotomamonjy, and Julien Audiffren. Operator-valued kernels for learning from functional response data. The Journal of Machine Learning Research, 17(1):613-666, 2016.

Eugenia Kalnay, Masao Kanamitsu, Robert Kistler, William Collins, Dennis Deaven, Lev

Gandin, Mark lredell, Suranjana Saha, Glenn White, John Woollen, et al. The ncep/ncar 40-year reanalysis project. Bulletin of the American meteorological Society, 77(3):437-472, 1996.

Angelos Katharopoulos, Apoory Vyas, Nikolaos Pappas, and Francois Fleuret. Transformers are rnns: Fast autoregressive transformers with linear attention. In International Conference on Machine Learning, pages 5156-5165. PMLR, 2020.

Diederik P Kingma and Jimmy Ba. Adam: A method for stochastic optimization. arXiv preprint arXiv:1412.6980, 2014.

Georgios Kissas, Yibo Yang, Eileen Hwuang, Walter R Witschey, John A Detre, and Paris Perdikaris. Machine learning in cardiovascular flows modeling: Predicting arterial blood pressure from non-invasive 4d flow mri data using physics-informed neural networks. Computer Methods in Applied Mechanics and Engineering, 358:112623, 2020.

Nikola Kovachki, Zongyi Li, Burigede Liu, Kamyar Azizzadenesheli, Kaushik Bhattacharya, Andrew Stuart, and Anima Anandkumar, Neural operator: Learning maps between function spaces. arXiv preprint arXiv2108.08481, 2021.

Samuel Lanthaler, Siddhartha Mishra, and George Em Karniadakis. Error estimates for deeponets: A deep learning framework in infinite dimensions. arXiv preprint arXiv:2102.09618, 2021.

Emma Lejeune. Mechanical mnist: A benchmark dataset for mechanical metamodels. Extreme Mechanics Letters, 36:100659, 2020.

Zongyi Li, Nikola Kovachki, Kamyar Azizzadenesheli, Burigede Liu, Kaushik Bhattacharya, Andrew Stuart, and Anima Anandkumar. Fourier neural operator for parametric partial differential equations. arXiv preprint arXiv2010.08895, 2020a.

Zongyi Li, Nikola Kovachki, Kamyar Azizzadenesheli, Burigede Liu, Kaushik Bhattacharya, Andrew Stuart, and Anima Anandkumar. Multipole graph neural operator for parametric partial differential equations. arXiv preprint arXiv:2006.09535, 2020b.

Zongyi Li, Nikola Kovachki, Kamyar Azizzadenesheli, Burigede Liu, Kaushik Bhattacharya, Andrew Stuart, and Anima Anandkumar. Neural operator: Graph kernel network for partial differential equations. arXiv preprint arXiv2003.03485, 2020c.

Chensen Lin, Zhen Li, Lu Lu, Shengze Cai, Martin Maxey, and George Em Karniadakis.

Operator learning for predicting multiscale bubble growth dynamics. The Journal of Chemical Physics, 154(10):104118, 2021.

Lu Lu, Pengzhan Jin, and George Em Karniadakis. Deeponet: Learning nonlinear operators for identifying differential equations based on the universal approximation theorem of operators. arXiv preprint arXiv:1910.03193. 2019.

Lu Lu, Xuhui Meng, Shengze Cai, Zhiping Mao, Somdatta Goswami, Zhongqiang Zhang, and George Em Karniadakis. A comprehensive and fair comparison of two neural operators (with practical extensions) based on fair data. arXiv preprint arXiv2111.05512, 2021.

Stephane Mallat. Group invariant scattering. Communications on Pure and Applied Mathematics, 65(10):1331-1398, 2012.

Charles A Micchelli and Massimiliano Pontil. Kernels for multi—task learning. In NIPS, volume 86, page 89. Citeseer, 2004.

Charles A Micchelli and Massimiliano Pontil. On learning vector-valued functions. Neural computation, 17(1):177-204, 2005.

Nicholas H Nelsen and Andrew M Stuart. The random feature model for input-output maps between banach spaces. arXiv preprint arXiv:2005.10224, 2020.

Houman Owhadi. Do ideas have shape? plato's theory of forms as the continuous limit of artificial neural networks. arXiv preprint arXiv:2008.03920_{;} 2020.

Edouard Oyallon, Eugene Belilovsky, and Sergey Zagoruyko. Scaling the scattering transform: Deep hybrid networks. In Proceedings of the IEEE international conference on computer vision, pages 5618-5627, 2017.

Niki Parmar, Ashish Vaswani, Jakob Uszkoreit, Lukasz Kaiser, Noam Shazeer, Alexander Ku, and Dustin Tran. Image transformer. In International Conference on Machine Learning, pages 4055-4064. PMLR, 2018.

Vern I Paulsen and Mrinal Raghupathi. An introduction to the theory of reproducing kernel Hilbert spaces, volume 152. Cambridge university press, 2016.

Ali Rahimi, Benjamin Recht, et al. Random features for large-scale kernel machines. In NIPS, volume 3, page 5. Citeseer, 2007.

Alvin Rajkomar, Jeffrey Dean, and Isaac Kohane. Machine learning in medicine. New England Journal of Medicine, 380(14):1347-1358,2019. James 0 Ramsay. When the data are functions. Psychometrika, 47(4):379-396, 1982.

James O Ramsay and C J Dalzell. Some tools for functional data analysis. Journal of the Royal Statistical Society: Series B (Methodological), 53(3):539-561, 1991.

Venkataraman Santhanam, Vlad I Morariu, and Larry S Davis. Generalized deep image to image regression. In Proceedings of the IEEE Conference on Computer Vision and Pattern Recognition, pages 5609-5619, 2017.

John Shawe-Taylor, Nello Cristianini, et al. Kernel methods for pattern analysis. Cambridge university press, 2004.

Bharath K. Sriperumbudur, Kenji Fukumizu, and Gert R. G. Lanckriet. Universality, characteristic kernels and RKHS embedding of measures. Journal of Machine Learning Research, 12(70):2389-2410, 2011. URL http://jmir.org/papers/v12/sriperumbudur11a.html.

Hiroyuki Takeda, Sina Farsiu, and Peyman Milanfar. Kernel regression for image processing and reconstruction. IEEE Transactions on image processing, 16(4349-366, 2007.

Yao-Hung Hubert Tsai, Shaojie Bai, Makoto Yamada, Louis-Philippe Morency, and Ruslan Salakhutdinov. Transformer dissection: An unified understanding for transformer's attention via the lens of kernel. arXiv preprint arXiv:1908.11775, 2019.

Ashish Vaswani, Noam Shazeer, Niki Parmar, Jakob Uszkoreit, Llion Jones, Aidan N

Gomez, Lukasz Kaiser, and Ilia Polosukhin. Attention is all you need. arXiv preprint arXiv:1706.03762, 2017.

Sifan Wang and Paris Perdikaris. Long-time integration of parametric evolution equations with physics-informed deeponets. arXiv preprint arXiv2106.05384, 2021.

Sifan Wang, Mohamed Aziz Bhouri, and Paris Perdikaris. Fast pde-constrained optimization via self-supervised operator learning. arXiv preprint arXiv:2110.13297, 2021a.

Sifan Wang, Hanwen Wang, and Paris Perdikaris. Improved architectures and training algorithms for deep operator networks. arXiv preprint arXiv:2110.01654, 2021 b.

Sifan Wang, Hanwen Wang, and Paris Perdikaris. Learning the solution operator of parametric partial differential equations with physics-informed deeponets. Science Advances, 7 (40):eabi8605, 2021c. doi: 10.1126/sciadv.abi8605.

Sinong Wang, Belinda Li, Madian Khabsa, Han Fang, and Hao Ma. Linformer: Self-attention with linear complexity. arXiv preprint arXiv:2006.04768, 2020.

Zelun Wang and Jyh-Charn Liu. Translating math formula images to latex sequences using deep neural networks with sequence-level training, 2019.

Yunyang Xiong, Zhanpeng Zeng, Rudrasis Chakraborty, Mingxing Tan, Glenn Fung, Yin Li, and Vikas Singh. Nyströmformer: A nyström-based algorithm for approximating self-attention. arXiv preprint arXiv:2102.03902, 2021.

### Nonlinear Manifold Decoders for Operator Learning

### Introduction

Machine learning techniques have been applied to great success for modeling functions between finite dimensional vector spaces. For example, in computer vision (vectors of pixel values) and natural language processing (vectors of word embeddings) these methods have produced state-of-the-art results in image recognition [15] and translation tasks [41]. However, not all data has an obvious and faithful representation as finite dimensional vectors. In particular, functional data is mathematically represented as a vector in an infinite dimensional vector space. This kind of data appears naturally in problems coming from physics, where scenarios in fluid dynamics, solid mechanics, and kinematics are described by functions of continuous quantities.

Supervised learning in the infinite dimensional setting can be considered for cases where we want to map functional inputs to target functional outputs. For example, we might wish to predict the velocity of a fluid as function of time given an initial velocity field, or predict the pressure field across the surface of the Earth given temperature measurements. This is similar to a finite dimensional regression problem, except that we are now interested in learning an operator between spaces of functions. We refer to this as a supervised operator learning problem: given a data-set of N pairs of functions {(u¹,s¹), . . . , (u^{N},s^{N})}, learn an operator F which maps input functions to output functions such that F(u¹)=sⁱ, ∀i.

One approach to solve the supervised operator learning problem is to introduce a parameterized operator architecture and train it to minimize a loss between the model's predicted functions and the true target functions in the training set. One of the first operator network architectures was presented in [6] with accompanying universal approximation guarantees in the uniform norm. These results were adapted to deep networks in [25] and led to the DeepONet architecture and its variants [44, 27, 16]. The Neural Operator architecture, motivated by the composition of linear and nonlinear layers in neural networks, was proposed in [22]. Using the Fourier convolution theorem to compute the integral transform in Neural Operators led to the Fourier Neural Operator [23]. Other recent architectures include approaches based on PCA-based representations [1], random feature approaches [30], wavelet approximations to integral transforms [13], and attention-based architectures [18].

A common feature shared among many of these approaches is that they aim to approximate an operator using three maps: an encoder, an approximator, and a decoder. In all existing approaches embracing this structure, the decoder is constructed as a linear map. In doing so, the set of target functions is being approximated with a finite dimensional linear subspace in the ambient target function space. Under this setting, the universal approximation theorems of [6, 19, 20] guarantee that there exists a linear subspace of a large enough dimension which approximates the target functions to any prescribed accuracy.

However, as with finite dimensional data, there are scenarios where the target functional data concentrates on a low dimensional nonlinear submanifold. We refer to the phenomenon of data in function spaces concentrating on low dimensional submanifolds as the Operator Learning Manifold Hypothesis. For example, it is known that certain classes of parametric partial differential equations admit low dimensional nonlinear manifolds of solution functions [7]. Although linear representations can be guaranteed to approximate these spaces, their required dimension can become very large and thus inefficient in capturing the true low dimensional structure of the data.

In this document, we are motivated by the Operator Learning Manifold Hypothesis to formulate a new class of operator learning architectures with nonlinear decoders. Our key contributions can be summarized as follows.

Limitations of Linear Decoders: We describe in detail the shortcomings of operator learning methods with linear decoders and present some fundamental lower bounds along with an illustrative operator learning problem which is subject to these limitations.
Nonlinear Manifold Decoders (NOMAD): This motivates a novel operator learning framework with a nonlinear decoder that can find low dimensional representations for finite dimensional nonlinear submanifolds in function spaces.
Enhanced Dimensionality Reduction: A collection of numerical experiments involving linear transport and nonlinear wave propagation shows that, by learning nonlinear submanifolds of target functions, we can build models that achieve state-of-the-art accuracy while requiring a significantly smaller number of latent dimensions.
Enhanced Computational Efficiency: As a consequence, the resulting architectures contain a significantly smaller number of trainable parameters and their training cost is greatly reduced compared to competing linear approaches.

### Related Work in Dimensionality Reduction

Low Dimensional Representations in Finite Dimensional Vector Spaces: Finding low dimensional representations of high dimensional data has a long history, going back to 1901 with the original formulation of principal components analysis (PCA) [32]. PCA is a linear method that works best when data concentrates on low dimensional subspaces. When data instead concentrates on low dimensional nonlinear spaces, kernelized PCA [35] and manifold learning techniques such as Isomap and diffusion maps [39, 9] can be effective in finding nonlinear low dimensional structure, see [40] for a review. The recent popularity of deep learning has introduced new methods for finding low dimensional structure in high dimensional data-sets, most notably using auto-encoders [45, 4] and deep generative models [10, 17]. Relevant to our work, such techniques have found success in approximating submanifolds in vector spaces corresponding to discretized solutions of parametric partial differential equations (PDEs) [36, 34, 12], where a particular need for nonlinear dimension reduction arises in advection-dominated problems common to fluid mechanics and climate science [21, 28].

Low Dimensional Representations in Infinite Dimensional Vector Spaces: The principles behind PCA generalize in a straightforward way to functions residing in low dimensional subspaces of infinite dimensional Hilbert spaces [43]. In the field of reduced order modeling of PDEs this is sometimes referred to as proper orthogonal decomposition [5] (see [24] for an interesting exposition of the discrete version and connections to the Karhunen-Loeve decomposition). Affine representations of solution manifolds to parametric PDEs and guarantees on when they are effective using the notion of linear n-widths [33] have been explored in [7]. As in the case of finite dimensional data, using a kernel to create a feature representation of a set of functions, and then performing PCA in the associated Reproducing Kernel Hilbert Space can give nonlinear low dimensional representations [38]. The theory behind optimal nonlinear low dimensional representations for sets of functions is still being developed, but there has been work towards defining what “optimal” should mean in this context and how it relates to more familiar geometric quantities [8].

### Operator Learning

Notation: Let us first set up some notation and give a formal statement of the supervised operator learning problem. We define C(X;R^{d}) as the set of continuous functions from a set X to R^{d}. When X ⊂ Rⁿ, we define the Hilbert space,

L²( [symbol] ; [symbol] ^{d})={ƒ: [symbol] → [symbol] ^{d} |∥ƒ∥_{L}_{²}²:=∫ₓ|ƒ(x) [symbol] dx<∝}

This is an infinite dimensional vector space equipped with the inner product [symbol] ƒ, g [symbol] =∫_{X}ƒ(x)g(x)dx. When X is compact, we have that C(X;R^{d}) ⊂ L²(X; R^{d}). We now can present a formal statement of the supervised operator learning problem.

Problem Formulation: Suppose we are given a training data-set of N pairs of functions (uⁱ,sⁱ), where uⁱ ∈ C(X;R^{du}) with compact X ⊂ R^{dx}, and sⁱ ⊂ C( [symbol] ; [symbol] ^{dx})with compact Y ⊂ R^{dy}. Assume there is a ground truth operator [symbol] :C( [symbol] ; [symbol] ^{d}^{ᵤ})→C( [symbol] ; [symbol] ^{d}^{ₐ}) such that G(uⁱ)=sⁱ and that the uⁱ are sampled i.i.d. from a probability measure on C(X;R^{d}). The goal of the supervised operator learning problem is to learn a continuous operator F: C(X;R^{dx})→C(Y;R^{ds}) to approximate G. To do so, we will attempt to minimize the following empirical risk over a class of operators Fθ, with parameters θ∈⊖⊂R^{de},

$$ℒ ( θ ) : = \frac{1}{N} {\sum }_{i = 1}^{N} {‖ {ℱ}_{θ} ( {u}^{i} ) - {s}^{i} ‖}_{{L}^{2} ( y ; {ℝ}^{{d}_{u}} )}^{2} . \qquad ( 1 )$$

FIG. 12 illustrates the operator learning manifold hypothesis by showing an encoder, approximator, and decoder.

An Approximation Framework for Operators: A popular approach to learning an operator G:L²(X)→L²(Y) acting on a probability measure μ on L²(X) is to construct an approximation out of three maps [20],

[symbol]

≈ [symbol] := [symbol] ∘ [symbol] ∘ε. (2)

The first map, E:L²(X)→R^{m} is known as the encoder. It takes an input function and maps it to a finite dimensional feature representation. For example, E could take a continuous function to its point-wise evaluations along a collection of m sensors, or project a function onto m basis functions. The next map A:R^{m}→Rⁿ is known as the approximation map. This can be interpreted as a finite dimensional approximation of the action of the operator G. Finally, the image of the approximation map is used to create the output functions in L²(Y) by means of the decoding map D:Rⁿ→L²(Y). We will refer to the dimension, n, of the domain of the decoder as the latent dimension. The composition of these maps can be visualized in the following diagram.

$$\begin{matrix}{L}^{2} ( 𝒳 ) & {⟶}^{𝒢} & {L}^{2} ( y ) \\ ↓ ε & & 𝒟 ↑ \\ {ℝ}^{m} & {⟶}^{A} & {ℝ}^{n}\end{matrix} \qquad ( 3 )$$

Linear Decoders: Many successful operator learning architectures such as the DeepONet [25], the (pseudo-spectral) Fourier Neural Operator in [19], LOCA [18], and the PCA-based method in [1] all use linear decoding maps D. A linear D can be defined by a set of functions Tᵢ ∈ L²(Y), i=1, . . . , n, and acts on a vector β ∈ Rⁿ as

D(β)=β₁T₁+. . . +βₙTₙ. (4)

For example, the functions Tᵢ can be built using trigonometric polynomials as in the ψ-FNO [19], be parameterized by a neural network as in DeepONet [25], or created as the normalized output of a kernel integral transform as in LOCA [18].

Limitations of Linear Decoders: We can measure the approximation accuracy of the operator F with two different norms. First is the L²(μ) operator norm,

$${‖ ℱ - 𝒢 ‖}_{{L}^{2} ( μ )}^{2} = {𝔼}_{u \sim μ} [ {‖ ℱ ( u ) - 𝒢 ( u ) ‖}_{{L}^{3}}^{2} ] . \qquad ( 5 )$$

Note that the empirical risk used to train a model for the supervised operator learning problem (see (1)) is a Monte Carlo approximation of the above population loss. The other option to measure the approximation accuracy is the uniform operator norm.

$${sup}_{u ∈ 𝒰} {‖ ℱ ( u ) - 𝒢 ( u ) ‖}_{{L}^{2} ( 𝓎 )} . \qquad ( 6 )$$

When a linear decoder is used for [symbol] = [symbol] ∘ [symbol] ∘ε, a data-dependent lower bound to each of these errors can be derived.

L² lower bound: When the pushforward measure has a finite second moment, its covariance operator ┌:L²(Y)→L²(Y) is self-adjoint, positive semi-definite, and trace-class, and thus admits an orthogonal set of eigenfunctions spanning its image, {φ₁,φ₂, . . .} with associated decreasing eigenvalues λ₁≥λ₂≥. . . . The decay of these eigenvalues indicates the extent to which samples from G#μ concentrate along the leading finite-dimensional eigenspaces. It was shown in [20] that for any choice of E and A, these eigenvalues give a fundamental lower bound to the expected squared L² error of the operator learning problem with architectures as in (3) using a linear decoder D.

$${𝔼}_{u \sim μ} [ {‖ 𝒟 ∘ 𝒜 ∘ ℰ ( u ) - 𝒢 ( u ) ‖}_{{L}^{2}}^{2} ] \geq {\sum }_{k > n} {λ}_{k} . \qquad ( 7 )$$

This result can be further refined to show that the optimal choice of functions Tᵢ (see equation (4)) for a linear decoder are given by the leading n eigenfunctions of the covariance operator {100 ₁, . . . , φₙ}. The interpretation of this result is that the best way to approximate samples from G#μ with an n-dimensional subspace is to use the subspace spanned by the first n “principal components” of the probability measure G#μ. The error incurred by using this subspace is determined by the remaining principal components, namely the sum of their eigenvalues P_{k>n} λₖ. The operator learning literature has noted that for problems with a slowly decaying pushforward covariance spectrum (such as solutions to advection-dominated PDEs) these lower bounds cause poor performance for models of the form (3) [20, 11].

Uniform lower bound: In the reduced order modelling of PDEs literature [7, 8, 21] there exists a related notion for measuring the degree to an n-dimensional subspace can approximate a set of functions S ∈ L²(Y). This is known as the Kolmogorov n-width [33], and for a compact set S is defined as

$${d}_{n} ( 𝒮 ) = {inf}_{{V}_{n} ⊂ {L}^{2} ( 𝓎 )} {sup}_{s ∈ 𝒮} {inf}_{v ∈ {V}_{n}} {‖ s - v ‖}_{{L}^{2} ( 𝓎 )} . \qquad ( 8 )$$

Vₙ is a subspace dim(Vₙ)=n

This measure of how well a set of functions can be approximated by a linear subspace in the uniform norm leads naturally to a lower bound for the uniform error (6). To see this, first note that for any u ∈ U, the error from F(u) to G(u) is bounded by the minimum distance from G(u) to the image of F. For a linear decoder D:Rⁿ→L²(Y), define the (at most) n-dimensional Vₙ=im(D) ⊂ L²(Y). Note that im(F) ⊆ Vₙ, and we may write

$${‖ ℱ ( u ) - 𝒢 ( u ) ‖}_{{L}^{2} ( 𝓎 )} \geq {inf}_{v ∈ {V}_{n}} {‖ v - 𝒢 ( u ) ‖}_{{L}^{2} ( 𝓎 )} .$$

Taking the supremum of both sides over u ∈ U, and then the infimum of both sides over all n-dimensional subspaces Vₙ gives

$${sup}_{u ∈ 𝒰} {‖ ℱ ( u ) - 𝒢 ( u ) ‖}_{{L}^{2} ( 𝓎 )} \geq {inf}_{\begin{matrix}{V}_{n} ⊂ {L}^{2} ( 𝓎 ) \\ {V}_{n} is a subspace \\ dim ( {V}_{n} ) = n\end{matrix}} {sup}_{u ∈ 𝒰} {inf}_{v ∈ {V}_{n}} {‖ v - 𝒢 ‖}_{{L}^{2} ( 𝓎 )}$$

The quantity on the right is exactly the Kolmogorov n-width of G(U). We have thus proved the following complementary statement to (7) when the error is measured in the uniform norm.

Proposition 1 Let U ∈ L²(X) be compact and consider an operator learning architecture as in (3), where D:Rⁿ→L²(Y) is a linear decoder. Then, for any E:L²(X)→R^{p} and A:R^{p}→Rⁿ, the uniform norm error of F:=D·A·E satisfies the lower bound

$${sup}_{u ∈ 𝒰} {‖ ℱ ( u ) - 𝒢 ( u ) ‖}_{{L}^{2} ( 𝓎 )} \geq {d}_{n} ( 𝒢 ( 𝒰 ) ) . \qquad ( 9 )$$

Therefore, we see that in both the L²(μ) and uniform norm, the error for an operator learning problem with a linear decoder is fundamentally limited by the extent to which the space of output functions “fits” inside a finite dimensional linear subspace. In the next section we will alleviate this fundamental restriction by allowing decoders that can learn nonlinear embeddings of Rⁿ into L²(Y).

Nonlinear Decoders for Operator Learning

A Motivating Example: Consider the problem of learning the antiderivative operator mapping functions to their first-order derivative

[symbol]

:u [symbol] s(x):=∫ₒ^{x}u(y)dy, (10)

acting on a set of input functions

[symbol]

:={u(x)=2πt cos(2πtx)|0≤t₀≤t≤T}. (11)

The set of output functions is given by G(U)={sin(2πtx)|0<t₀<t<T}. This is a one-dimensional curve of functions in L²([0,1]) parameterized by a single number t. However, we would not be able to represent this set of functions with a one-dimensional linear subspace.

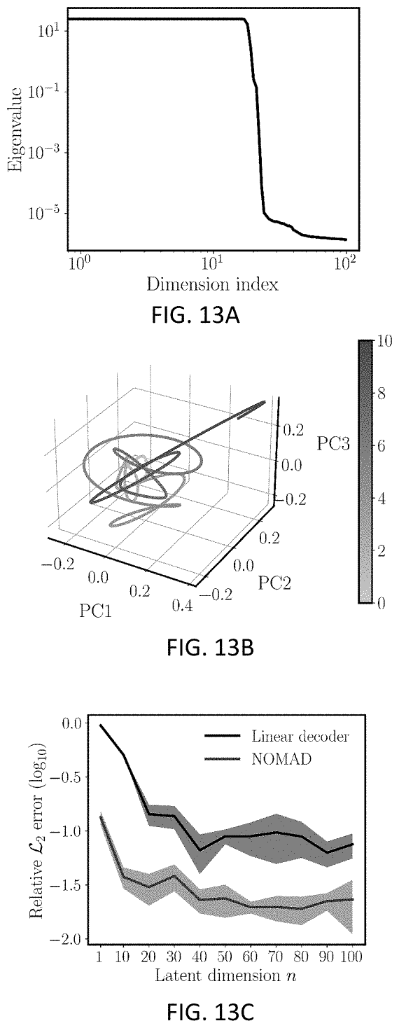

FIGS. 13A-C illustrate an antiderivative example. FIG. 13A shows a log plot of the leading 100 PCA eigenvalues of G(U). FIG. 13B shows a projection of functions in the image of G(U) on the first three PCA components, shaded by the frequency of each projected function. FIG. 13C is a chart showing relative L² testing error (logio scale) as a function of latent dimension n for linear and nonlinear decoders (over 10 independent trials).

In FIG. 13B we perform PCA on the functions in this set evaluated on a uniform grid of values of t. We see that the first 20 eigenvalues are nonzero and relatively constant, suggesting that an operator learning architecture with a linear or affine decoder would need a latent dimension of at least 20 to effectively approximate functions from G(U). FIG. 13A gives a visualization of this curve of functions projected onto the first three PCA components. An architecture with a nonlinear decoder can in fact approximate the target output functions with superior accuracy compared to the linear case, using a single latent dimension that can capture the underlying nonlinear manifold structure.

Operator Learning Manifold Hypothesis: We now describe an assumption under which a nonlinear decoder is expected to be effective, and use this to formulate the NOMAD architecture. To this end, let μ be a probability measure on L²(X) and G:L²(X)→L²(Y). We assume that there exists an n-imensional manifold M ⊆ L²(Y) and an open subset O ⊂ M such that

$${𝔼}_{u \sim μ} [ {inf}_{v ∈ 𝒪} {‖ 𝒢 ( u ) - v ‖}_{{L}^{2}}^{2} ] \leq ϵ . \qquad ( 12 )$$

In connection with the manifold hypothesis in deep learning [3, 2], we refer to this as the Operator Learning Manifold Hypothesis. There are scenarios where it is known this assumption holds, such as in learning solutions to parametric PDEs [28].

This assumption motivates the construction of a nonlinear decoder for the architecture in (3) as follows. For each u. choose v(u) ∈ O such that

$${𝔼}_{u \sim μ} [ {‖ 𝒢 ( u ) - v ( u ) ‖}_{{L}^{2}}^{2} ] \leq ϵ . \qquad ( 13 )$$

Let φ:O→Rⁿ be a coordinate chart for O ⊂ M. We can represent v(u) ⊂O by its coordinates φ(v(u)) ⊂ Rⁿ. Consider a choice of encoding and approximation maps such that A(E(u)) gives the coordinates for v(u). If the decoder were chosen as D:=φ⁻¹ then by construction, the operator F:=D·A·E will satisfy

$${𝔼}_{u \sim μ} [ {‖ 𝒢 ( u ) - ℱ ( u ) ‖}_{{L}^{2}}^{2} ] \leq ϵ . \qquad ( 14 )$$

Therefore, we interpret a learned decoding map as attempting to give a finite dimensional coordinate system for the solution manifold. Consider a generalized decoder of the following form

[symbol]

: [symbol] ⁿ× [symbol] → [symbol] . (15)

This induces a map from D:Rⁿ→L²(Y), as D(β)=D~(β,·). If the solution manifold M is a finite dimensional linear subspace in

L²(Y) spanned by {Tᵢ}ᵢ₌₁ⁿ, we would want a decoder to use the coefficients along the basis as a coordinate system for M. A generalized decoder could learn this basis as the output of a deep neural network to act as

[symbol]

ᵢₙ(β,y)= [symbol] (y)+. . . + [symbol] (y), (16)

However, if the solution manifold is not linear, then we should learn a nonlinear coordinate system given by a nonlinear D. A nonlinear version of [symbol] can be parameterized by using a deep neural network f:Rⁿ×Y→R which jointly takes as arguments (β,y),

[symbol]

(β,y)=∫(β,y), (17)

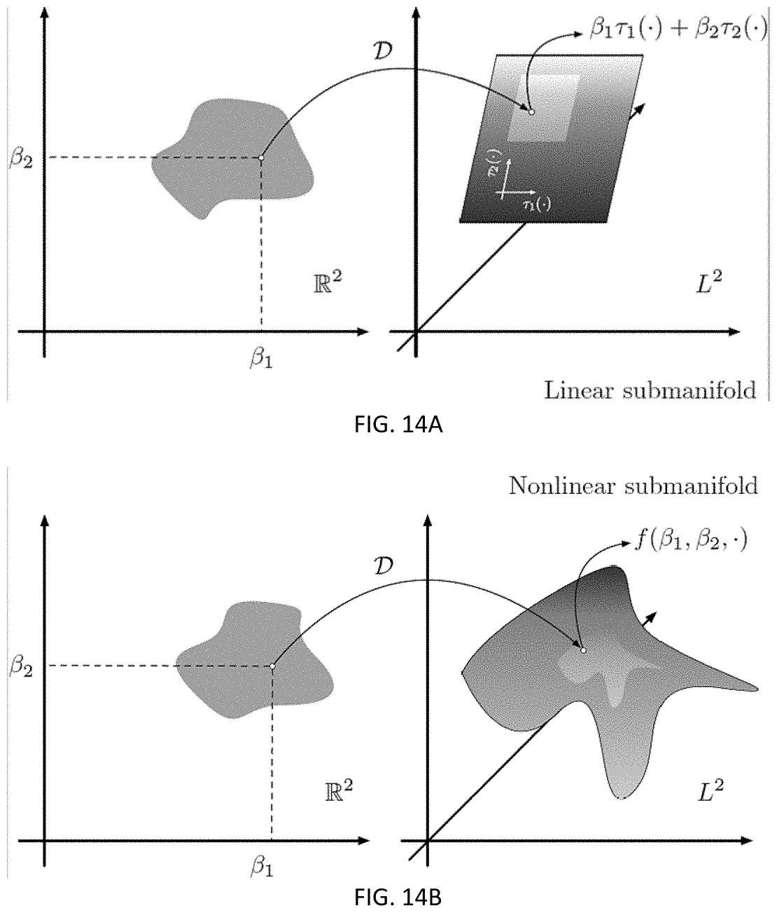

When used in the context of an operator learning architecture of the form (3), we call a nonlinear decoder from (17) NOMAD (NOnlinear MAnifold Decoder). FIGS. 14A-B present a visual comparison between linear and nonlinear decoders. FIG. 14A shows an example with a linear submanifold. FIG. 14B shows an example with a nonlinear submanifold.

Summary of NOMAD: Under the assumption of the Operator Learning Manifold Hypothesis, we have proposed a fully nonlinear decoder (17) to represent target functions using architectures of the form (3). We next show that using a decoder of the form (17) results in operator learning architectures which can learn nonlinear low dimensional solution manifolds. Additionally, we will see that when these solution manifolds do not “fit” inside low dimensional linear subspaces, architectures with linear decoders will either fail or require a significantly larger number of latent dimensions.

### Results

In this section we investigate the effect of using a linear versus nonlinear decoders as building blocks of operator learning architecture taking the form (3). In all cases, we will use an encoder E which takes point-wise evaluations of the input functions, and an approximator map A given by a deep neural network. The linear decoder parametrizes a set of basis functions that are learned as the outputs of an MLP network. In this case, the resulting architecture exactly corresponds to the DeepONet model from [25]. We will compare this against using NOMAD where the nonlinear decoder is built using an MLP network that takes as inputs the concatenation of β ∈ Rⁿ and a given query point y ∈ Y. All models are trained with by performing stochastic gradient descent on the loss function in (1). The reported errors are measured in the relative L²(Y) norm by averaging over all functional pairs in the testing data-set.

Learning the Antiderivative Operator: First, we revisit the motivating example shown above, where the goal is to learn the antiderivative operator (10) acting on the set of functions (11). In FIG. 13C we see the performance of a model with a linear decoder and NOMAD over a range of latent dimensions n. For each choice of n, 10 experiments with random initialization seeds were performed, and the mean and standard deviation of testing errors are reported. We see that the NOMAD architecture consistently outperforms the linear one (by one order of magnitude), and can even achieve a 10% relative prediction error using only n=1.

Solution Operator of a Parametric Advection PDE: Here we consider the problem of learning the solution operator to a PDE describing the transport of a scalar field with conserved energy,

$$\frac{\partial }{\partial t} s ( x , t ) + \frac{\partial }{\partial x} s ( x , t ) = 0 , \qquad ( 18 )$$

over a domain (x,t) ∈ [0,2]×[0,1]. The solution operator maps an initial condition s(x,0)=u(x) to the solution at all times s(x,t) which satisfies (18).

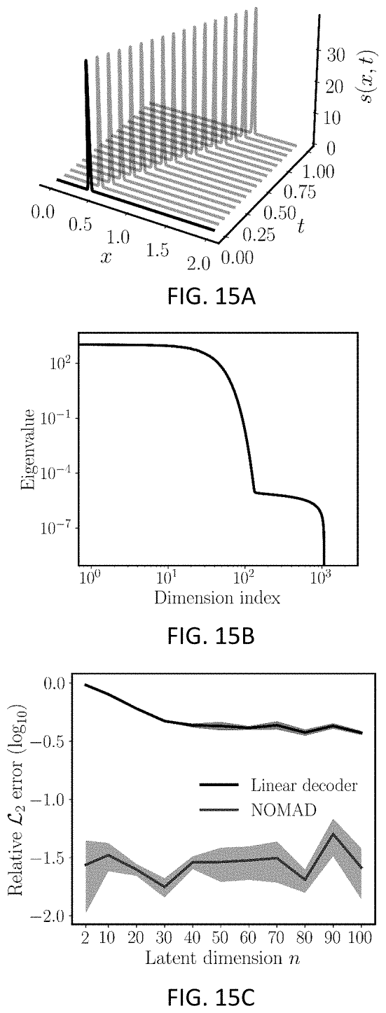

We consider a training data-set of initial conditions taking the form of radial basis functions with a very small fixed lengthscale centered at randomly chosen locations in the interval [0,1]. We create the output functions by evolving these initial conditions forward in time for 1 time unit according to the advection equation (18). FIG. 15A gives an illustration of one such solution plotted over the space-time domain.

Performing PCA on the solution functions generated by these initial conditions shows a very slow decay of eigenvalues (see FIG. 15B), suggesting that methods with linear decoders will require a moderately large number of latent dimensions. However, since the data-set was constructed by evolving a set of functions with a single degree of freedom (the center of the initial conditions), we would expect the output functions to form a solution manifold of very low dimension.

In FIG. 15C we compare the performance of a linear decoder and NOMAD as a function of the latent dimension n. Linear decoders yield poor performance for small values of n, while NOMAD appears to immediately discover a good approximation to the true solution manifold.

FIGS. 15A-C illustrate the advection equation example. FIG. 15A shows propagation of an initial condition function (highlighted in black) through time according to (18). FIG. 15B shows the log of the leading 1,000 PCA eigenvalues of G(U). FIG. 15C shows the relative L² testing error (log₁₀ scale) as a function of latent dimension n for linear and nonlinear decoders (over 10 independent trials).

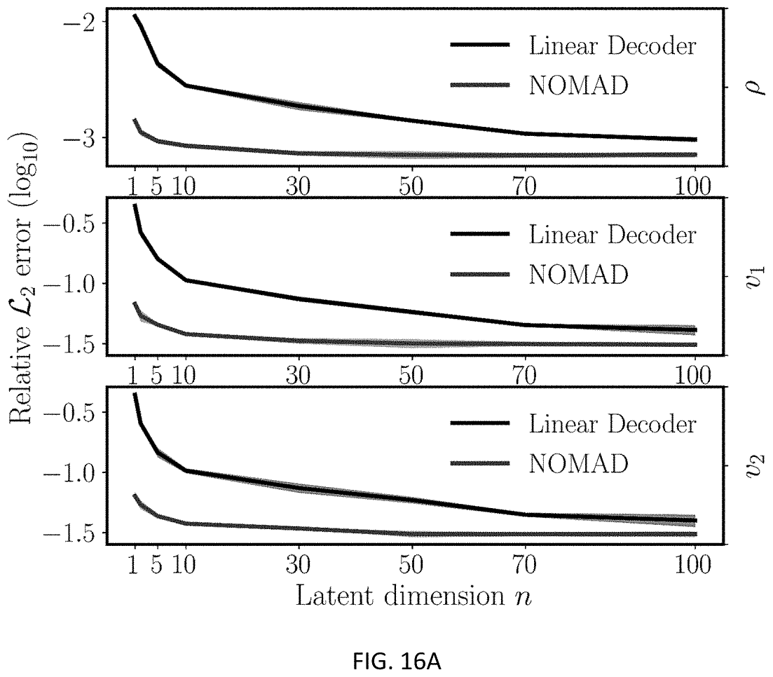

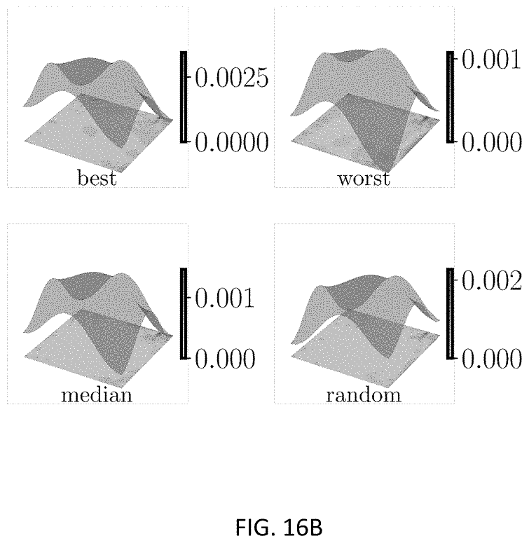

Propagation of Free-surface Waves: As a more challenging benchmark we consider the shallow-water equations; a set of hyperbolic equations that describe the flow below a pressure surface in a fluid [42]. The underlying PDE system takes the form

$$\frac{\partial U}{\partial t} + \frac{\partial F}{\partial x} + \frac{\partial G}{\partial y} = 0 , \qquad ( 19 )$$

$$where ,$$

$$U = ( \begin{matrix}ρ \\ ρ {v}_{1} \\ ρ {v}_{2}\end{matrix} ) , F = ( \begin{matrix}ρ {v}_{1} \\ ρ {v}_{1}^{2} + \frac{1}{2} g {ρ}^{2} \\ ρ {v}_{1} {v}_{2}\end{matrix} ) , G = ( \begin{matrix}ρ {v}_{2} \\ ρ {v}_{1} {v}_{2} \\ ρ {v}_{2}^{2} + \frac{1}{2} g {ρ}^{2}\end{matrix} ) . \qquad ( 20 )$$

where ρ(x,y,t) the fluid height from the free surface, g is the gravity acceleration, and v₁(x,y,t), v₂(x,y,t) denote the horizontal and vertical fluid velocities, respectively. We consider reflective boundary conditions and random initial conditions corresponding to a random droplet falling into a still fluid bed. In FIG. 16A we show the average testing error of a model with a linear and nonlinear decoder as a function of the latent dimension. FIG. 16B shows snapshots of the predicted surface height function on top of a plot of the errors to the ground truth for the best, worst, median, and a random sample from the testing data-set.

FIGS. 16A-B illustrate an example with propagation of free-surface waves. FIG. 16A shows the relative L² testing error (login scale) as a function of latent dimension n for linear and nonlinear decoders (over 10 independent trials). FIG. 16B shows a visualization of predicted free surface height ρ(x,y,t=0.31) and point-wise absolute prediction error contours corresponding to the best, worst, and median samples in the test data-set, along with a representative test sample chosen at random. We additionally use this example to compare the performance of a model with a linear decoder and NOMAD to other state-of-the-art operator learning architectures.

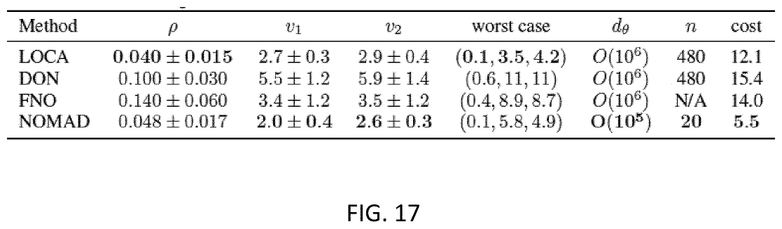

FIG. 17 shows Table 1: Comparison of relative L² errors (in %) for the predicted output functions for the shallow water equations benchmark against existing state-of-the-art operator learning methods: LOCA [18], DeepONet (DON) [25], and the Fourier Neural Operator (FNO) [23]. The fourth column reports the relative L² error for (ρ,v₁,v₂) corresponding to the worst case example in the test data-set. Also shown is each model's total number of trainable parameters d_{θ}, latent dimension n, and computational cost in terms of training time (minutes).

In Table 1, we present the mean relative error and its standard deviation for different operator learning methods, as well as the prediction that provides the worst error in the testing data-set when compared against the ground truth solution. For each method we also report the number of its trainable parameters, the number of its latent dimension n, and the training wall-clock time in minutes. Since the general form of the FNO [23] does not neatly fit into the architecture given by (3), there is not a directly comparable measure of latent dimension for it. We also observe that, although the model with NOMAD closely matches the performance of LOCA [18], its required latent dimension, total number of trainable parameters, and total training time are all significantly smaller.

### Discussion

Summary: We have presented a novel framework for supervised learning in function spaces. The proposed methods aim to address challenging scenarios where the manifold of target functions has low dimensional structure, but is embedded nonlinearly into its associated function space. Such cases commonly arise across diverse functional observables in the physical and engineering sciences (e.g. turbulent fluid flows, plasma physics, chemical reactions), and pose a significant challenge to the application of most existing operator learning methods that rely on linear decoding maps, forcing them to require an excessively large number of latent dimensions to accurately represent target functions. To address this shortcoming we put forth a fully nonlinear framework that can effectively learn low dimensional representations of nonlinear embeddings in function spaces, and demonstrated that it can achieve competitive accuracy to state-of-the-art operator learning methods while using a significantly smaller number of latent dimensions, leading to lighter model parametrizations and reduced training cost.

The disclosure of each of the following references is incorporated herein by reference in its entirety. References
[1] Kaushik Bhattacharya, Bamdad Hosseini, Nikola B Kovachki, and Andrew M Stuart. Model reduction and neural networks for parametric PDEs. The SMAI journal of computational mathematics, 7:121-157, 2021.
[2] Pratik Prabhanjan Brahma, Dapeng Wu, and Yiyuan She. Why deep learning works: A manifold disentanglement perspective. IEEE transactions on neural networks and learning systems, 27(10):1997-2008, 2015.
[3] Lawrence Cayton. Algorithms for manifold learning. Univ. of California at San Diego Tech. Rep, 12(1-1 7):1, 2005.
[4] Kathleen Champion, Bethany Lusch, J Nathan Kutz, and Steven L Brunton. Data-driven discovery of coordinates and governing equations. Proceedings of the National Academy of Sciences, 116(45):22445-22451, 2019.
[5] Anindya Chatterjee. An introduction to the proper orthogonal decomposition. Current Science, pages 808-817, 2000.
[6] Tianping Chen and Hong Chen. Universal approximation to nonlinear operators by neural networks with arbitrary activation functions and its application to dynamical systems. IEEE Transactions on Neural Networks, 6(4):911-917, 1995.
[7] Albert Cohen and Ronald DeVore. Approximation of high-dimensional parametric PDEs. Acta Numerica, 24:1-159, 2015.

[8] Albert Cohen, Ronald Devore, Guergana Petrova, and Przemyslaw Wojtaszczyk. Optimal stable nonlinear approximation. Foundations of Computational Mathematics, pages 1-42, 2021.
[9] Ronald R Coif man and Stéphane Lafon. Diffusion maps. Applied and computational harmonic analysis, 21(1):5-30, 2006.
[10] Antonia Creswell, Tom White, Vincent Dumoulin, Kai Arulkumaran, Biswa Sengupta, and Anil A Bharath. Generative adversarial networks: An overview. IEEE Signal Processing Magazine, 35(1):53-65, 2018.
[11] Maarten De Hoop, Daniel Zhengyu Huang, Elizabeth Qian, and Andrew M Stuart. The costaccuracy trade-off in operator learning with neural networks. arXiv preprint arXiv:2203.13181, 2022.
[12] Rudy Geelen, Stephen Wright, and Karen Willcox. Operator inference for non-intrusive model reduction with nonlinear manifolds. arXiv preprint arXiv:2205.02304, 2022.
[13] Gaurav Gupta, Xiongye Xiao, and Paul Bogdan. Multiwavelet-based operator learning for differential equations. Advances in Neural Information Processing Systems, 34, 2021.
[14] David Ha, Andrew M. Dai, and Quoc V. Le. Hypernetworks. In 5th International Conference on Learning Representations, ICLR 2017, Toulon, France, April 24-26, 2017, Conference Track Proceedings, 2017.
[15] Kaiming He, Xiangyu Zhang, Shaoqing Ren, and Jian Sun. Deep residual learning for image recognition. In Proceedings of the IEEE conference on computer vision and pattern recognition, pages 770-778, 2016.
[16] Pengzhan Jin, Shuai Meng, and Lu Lu. MIONet: Learning multiple-input operators via tensor product. arXiv preprint arXiv:2202.06137, 2022.
[17] Diederik P. Kingma and Max Welling. Auto-Encoding Variational Bayes. In Yoshua Bengio and Yann LeCun, editors, 2nd International Conference on Learning Representations, ICLR 2014, Banff, A B, Canada, April 14-16, 2014, Conference Track Proceedings, 2014.
[18] Georgios Kissas, Jacob Seidman, Leonardo Ferreira Guilhoto, Victor M Preciado, George J Pappas, and Paris Perdikaris. Learning Operators with Coupled Attention. arXiv preprint arXiv:2201.01032, 2022.
[19] Nikola Kovachki, Samuel Lanthaler, and Siddhartha Mishra. On universal approximation and error bounds for fourier neural operators. Journal of Machine Learning Research, 22:Art—No, 2021.
[20] Samuel Lanthaler, Siddhartha Mishra, and George E Karniadakis. Error estimates for DeepONets: A deep learning framework in infinite dimensions. Transactions of Mathematics and Its Applications, 6(1):tnac001, 2022.
[21] Kookjin Lee and Kevin T Carlberg. Model reduction of dynamical systems on nonlinear manifolds using deep convolutional autoencoders. Journal of Computational Physics, 404:108973, 2020.
[22] Zongyi Li, Nikola Kovachki, Kamyar Azizzadenesheli, Burigede Liu, Kaushik Bhattacharya, Andrew Stuart, and Anima Anandkumar. Neural operator: Graph kernel network for partial differential equations. arXiv preprint arXiv:2003.03485, 2020.
[23] Zongyi Li, Nikola Borislavov Kovachki, Kamyar Azizzadenesheli, Kaushik Bhattacharya, Andrew Stuart, Anima Anandkumar, et al. Fourier Neural Operator for parametric partial differential equations. In International Conference on Learning Representations, 2020.
[24] Y C Liang, H P Lee, S P Lim, W Z Lin, K H Lee, and CG1237 Wu. Proper orthogonal decomposition and its applications—Part I: Theory. Journal of Sound and vibration, 252(3):527-544, 2002.
[25] Lu Lu, Pengzhan Jin, Guofei Pang, Zhongqiang Zhang, and George Em Karniadakis. Learning nonlinear operators via DeepONet based on the universal approximation theorem of operators. Nature Machine Intelligence, 3(3):218-229, 2021.
[26] Lu Lu, Xuhui Meng, Shengze Cai, Zhiping Mao, Somdatta Goswami,

Zhongqiang Zhang, and George Em Karniadakis. A comprehensive and fair comparison of two neural operators (with practical extensions) based on fair data. arXiv preprint arXiv:2111.05512, 2021.
[27] Lu Lu, Xuhui Meng, Shengze Cai, Zhiping Mao, Somdatta Goswami, Zhongqiang Zhang, and George Em Karniadakis. A comprehensive and fair comparison of two neural operators (with practical extensions) based on FAIR data. Computer Methods in Applied Mechanics and Engineering, 393:114778, 2022.
[28] Romit Maulik, Bethany Lusch, and Prasanna Balaprakash. Reduced-order modeling of advection-dominated systems with recurrent neural networks and convolutional autoencoders. Physics of Fluids, 33(3):037106, 2021.
[29] Parviz Moin. Fundamentals of engineering numerical analysis. Cambridge University Press, 2010.
[30] Nicholas H Nelsen and Andrew M Stuart. The random feature model for input-output maps between Banach spaces. SIAM Journal on Scientific Computing, 43(5):A3212—A3243, 2021.
[31] Shaowu Pan, Steven L Brunton, and J Nathan Kutz. Neural implicit flow: a mesh-agnostic dimensionality reduction paradigm of spatio-temporal data. arXiv preprint arXiv:2204.03216, 2022.
[32] Karl Pearson. Liii. on lines and planes of closest fit to systems of points in space. The London, Edinburgh, and Dublin philosophical magazine and journal of science, 2(11) :559-572, 1901.
[33] Allan Pinkus. N-widths in Approximation Theory, volume 7. Springer Science & Business Media, 2012.
[34] Wilhelmus H A Schilders, Henk A Van der Vorst, and Joost Rommes. Model order reduction: theory, research aspects and applications, volume 13. Springer, 2008.
[35] Bernhard Scholkopf, Alexander Smola, and Klaus-Robert Muller. Nonlinear component analysis as a kernel eigenvalue problem. Neural computation, 10(5):1299-1319, 1998.
[36] Lawrence Sirovich. Turbulence and the dynamics of coherent structures. i. coherent structures. Quarterly of applied mathematics, 45(3):561-571, 1987.
[37] Vincent Sitzmann, Julien Martel, Alexander Bergman, David Lindell, and Gordon Wetzstein. Implicit neural representations with periodic activation functions. Advances in Neural Information Processing Systems, 33:7462-7473, 2020.
[38] Jun Song and Bing Li. Nonlinear and additive principal component analysis for functional data. Journal of Multivariate Analysis, 181:104675, 2021.
[39] Joshua B Tenenbaum, Vin de Silva, and John C Langford. A global geometric framework for nonlinear dimensionality reduction. Science, 290(5500):2319-2323, 2000.
[40] Laurens van der Maaten, Eric O. Postma, and Jaap van den Herik. Dimensionality reduction: A comparative review. 2009.
[41] Ashish Vaswani, Noam Shazeer, Niki Parmar, Jakob Uszkoreit, Llion Jones, Aidan N Gomez, Lukasz Kaiser, and Illia Polosukhin. Attention is all you need. Advances in neural information processing systems, 30, 2017.
[42] Cornelis Boudewijn Vreugdenhil. Numerical methods for shallow-water flow, volume 13. Springer Science & Business Media, 1994.
[43] Jane-Ling Wang, Jeng-Min Chiou, and Hans-Georg Müller. Functional data analysis. Annual Review of Statistics and Its Application, 3:257-295, 2016.
[44] Sifan Wang, Hanwen Wang, and Paris Perdikaris. Improved architectures and training algorithms for deep operator networks. arXiv preprint arXiv:2110.01654, 2021.
[45] Yasi Wang, Hongxun Yao, and Sicheng Zhao. Auto-encoder based dimensionality reduction. Neurocomputing, 184:232-242, 2016.

The following sections contain additional details regarding the NOMAD material described above.

### Nomenclature

Table 2 summarizes the main symbols and notation used in this work.

TABLE 2
(Nomenclature)
A summary of the main symbols and notaton used in this work.

| | |
|---|---|
| C′ (A, B) | Space of continuous functions from a space A is a space B. |
| L² | Hilbert space of square integrable functions. |
| [symbol] | Domain for input fmctions, subset of [symbol] ^{dx}, |
| [symbol] | Domain for output functions, subset of [symbol] ^{dy}, |
| x | Input function arguments. |
| y | Output function arguments (queries). |
| u | Input function in C( [symbol] , [symbol] ^{du} ) |
| s | Output function in C( [symbol] , [symbol] ^{ds} ) |
| n | Latent dimension for solution manifold |
| [symbol] , [symbol] | Operator mapping input functions u to output functions s. |

### B Architecture Choices and Hyper-parameter Settings

In this section, we present all architecture choices and training details considered in the experiments for the NOMAD and the DeepONet methods. For both NOMAD and DeepONet, we set the batch size of input and output pairs equal to 100. We consider an initial learning rate of Ir=0.001, and an exponential decay with decay-rate of 0.99 every 100 training iterations. For the results presented in 1, we consider the same set-up as in [18] for LOCA, DeepONet and FNO, while for NOMAD we use the same number of hidden layers and neurons as the DeepONet. The order of magnitude difference in number of parameters between NOMAD and DeepONet for the Shallow Water Equation comparison, come from the difference between the latent dimension choice between the two methods (n=20 for NOMAD and n=480 for DeepONet) and the fact the in [18] the authors implement the improvements for DeepONet proposed in [26], namely perform a Harmonic Feature Expansion for the input functions.

B.1 Model Architecture

In the DeepONet, the approximation map [symbol] : [symbol] ^{m}→ [symbol] ⁿ in is known as the branch network b, and the neural network whose outputs are the basis { [symbol] 1, . . . , [symbol] n} known as the trunk network, [symbol] . We present the structure of b and [symbol] in Table 3. The DeepONet employed in this work is the plain DeepONet version originally put forth in [26], without considering the improvements in [26, 44]. The reason for choosing the simplest architecture possible is because we are interest in examining solely the effect of the decoder without any additional moving parts. For the NOMAD method, we consider the same architecture as the DeepONet for each problem.

TABLE 3
Architecture choices for different examples.

| Example | b depth | b width | τ depth | τ depth |
|---|---|---|---|---|
| Antiderivative | 5 | 100 | 5 | 100 |
| Parametric Advection | 5 | 100 | 5 | 100 |
| Free Surface Waves | 5 | 100 | 5 | 100 |

TABLE 4
Training details for the experiments in this work. We present
the number of training and testing data pairs Nₜᵣₐᵢₙ
and Nₜₑₛₜ, respectively, the number of sensor locations
where the input functions are evaluated m, the number of
query points where the output functions are evaluated P, the
batch size, and total training iterations.

| | | | | | | Train |
|---|---|---|---|---|---|---|
| Example | Nₜᵣₐᵢₙ | Nₜₑₛₜ | m | P | Batch # | iterations |
| Antiderivative | 1000 | 1000 | 500 | 500 | 100 | 20000 |
| Parametric | 1000 | 1000 | 256 | 25600 | 100 | 20000 |
| Advection | | | | | | |
| Free Surface | 1000 | 1000 | 1024 | 128 | 100 | 100000 |
| Waves | | | | | | |

C Experimental Details

C.1 Data-Set Generation

For all experiments, we use Nₜᵣₐᵢₙ number of function pairs for training and Nₜₑₛₜ for testing. m and P number of points where the input and output functions are evaluated, respectively. See Table 4 for the values of these parameters for the different examples along with batch sizes and total training iterations. We train and test with the same data-set on each example for both NOMAD and DeepONet.

We build collections of measurements for each of the N input/output function pairs, (uⁱ; sⁱ) as follows. The input function is measured at m locations x₁ⁱ, . . . , xₘⁱ to give the point-wise evaluations, {uⁱ(x₁ⁱ), . . . , uⁱ (xₘⁱ)}. The output function is evaluated at P locations y₁ⁱ, . . . , y_{P}ⁱ, with these locations potentially varying over the data-set, to give the point-wise evaluations {sⁱ(y₁ⁱ), . . . , sⁱ(y_{P}ⁱ)}. Each data pair used in training is then given as ({uⁱ(xⱼⁱ)}ⱼ₌₁^{m}, {sⁱ( [symbol] ) [symbol] ).

C.2 Antiderivative

We approximate the antiderivative operator

[symbol]

:u [symbol] s(x):=ƒₒ^{x}u(y)dy,

acting on a set of input functions

[symbol]

:={u(x)=2πt cos(2πtx)|0≤t₀≤t≤T}.

The set of output functions is given by:

[symbol]

={sin (2πtx)|0<t₀<t<T}.

We consider x ∈ [symbol] =[0, 1] and the initial condition s(0)=0. For a given forcing term u the solution operator returns the antiderivative s(x). Our goal is to learn the solution operator [symbol] :C( [symbol] )→Ĉ( [symbol] ). In this case dₓ=d_{y}=dₛ=dᵤ=1.

To construct the data-sets we sample input functions u(x) by sampling t˜ [symbol] (0, 10) and evaluate these functions on m=500 equispaced sensor locations. We measure the corresponding output functions on P=500 equispaced locations. We construct Nₜᵣₐᵢₙ=1; 000 input/output function pairs for training and Nₜₑₛₜ=1; 000 pairs for testing the model.

C.3 Advection Equation

For demonstrating the benefits of our method, we choose a linear transport equation benchmark, similar to [12],

$$\frac{\partial }{\partial t} s ( x , t ) + c \frac{\partial }{\partial x} s ( x , t ) = 0 , \qquad ( 21 )$$

with initial condition

$${s}_{0} ( x ) = s ( x , 0 ) = \frac{1}{\sqrt{0.0002 π}} exp ( - \frac{{( x - μ )}^{2}}{0.0002} ) , \qquad ( 22 )$$

where μ is sampled from a uniform distribution μ~ [symbol] (0.05, 1). Here we have x ∈ [symbol] :=[0,2], and y=(x,t)∈ [symbol] :=[0,2]×[0,1]. Our goal is to learn the solution operator [symbol] :C( [symbol] )→C( [symbol] ). The advection equation admits an analytic solution

s(x,t)=s₀(x−ct,t), (23)

where the initial condition is propagated through the domain with speed c, as shown in FIG. 15A.

We construct training and testing data-sets by sampling Nₜᵣₐᵢₙ=1000 and Nₜₑₛₜ=1000 initial conditions and evaluate the analytic solution on Nₜ=100 temporal and Nₓ=256 spatial locations.

We use a high spatio-temporal resolution for training the model to avoid missing the narrow travelling peak in the pointwise measurements.

C.4 Shallow Water Equations

The shallow water equations are a hyperbolic system of equations that describe the flow below a pressure surface, given as

$$\frac{\partial ρ}{\partial t} + \frac{\partial ( ρ {v}_{1} )}{\partial {x}_{1}} + \frac{\partial ( ρ {v}_{2} )}{\partial {x}_{2}} = 0 , \qquad ( 24 )$$

$$\frac{\partial ( ρ {v}_{1} )}{\partial t} + \frac{\partial }{\partial {x}_{1}} ( ρ {v}_{1}^{2} + \frac{1}{2} g {ρ}^{2} ) + \frac{\partial ( ρ {v}_{1} {v}_{2} )}{\partial {x}_{2}} = 0 , t ∈ ( 0 , 1 ] , x ∈ {( 0 , 1 )}^{2}$$

$$\frac{\partial ( ρ {v}_{2} )}{\partial t} + \frac{\partial ( ρ {v}_{1} {v}_{2} )}{\partial {x}_{1}} + \frac{\partial }{\partial {x}_{2}} ( ρ {v}_{2}^{2} + \frac{1}{2} g {ρ}^{2} ) = 0 ,$$

where P is the total fluid column height, v₁ the velocity in the x₁ direction, v₂ the velocity in the x₂direction, and g the acceleration due to gravity.

We consider impenetrable reflective boundaries

v₁·nₓ_{₁}+v₂·nₓ_{₂}=0,

where \hat{n}=nₓ_{₁}î+nₓ_{₂}ĵ is the unit outward normal of the boundary.

Initial conditions are generated from a droplet of random width falling from a random height to a random spatial location and zero initial velocities

ρ=1+h exp(−((x₁−ξ)²+(x₂−ζ)²)/w)v₁=v₂=0,

where h corresponds to the altitude that the droplet falls from, w the width of the droplet, and x₁ and x₂ the coordinates that the droplet falls in time t=0s. Instead of choosing the solution for v₁; v₂ at time t₀=0s as the input function, we use the solution at dt=0.002s so the input velocities are not always zero. The components of the input functions are then

ρ=1+h exp(−((x₁−ξ)²+(x₂−ζ)²⁰)/w)

v₁=v₁(dt,y₁,y₂),

v₂=v₂(dt,y₁,y₂),

We set the random variables h, w, ξ, and ζ to be distributed according to the uniform distributions

h= [symbol] (1.5, 2.5),

w= [symbol] (0.002, 0.008),

ξ= [symbol] (0.4, 0.6),

ζ= [symbol] (0.4, 0.6).

In this example, x ∈ [symbol] :=(0,1)² and y=(x,t)∈(0,1)²×(0,1). For a given set of input functions, the solution operator G of 24 maps the fluid column height and velocity fields at time dt to the fluid column height and velocity fields at later times. Therefore, our goal is to learn a solution operator [symbol] : C( [symbol] )→C( [symbol] ).

We create a training and a testing data-set by sampling Nₜᵣₐᵢₙ=1000 and Nₜₑₛₜ=1000 input/output function samples by sampling initial conditions on a 32×32 grid, solving the equation using a Lax-Friedrichs scheme [29] and considering five snapshots t=[0.11; 0.16; 0.21; 0.26; 0.31]s. We randomly choose P=128 measurements from the available spatio-temporal data of the output functions per data pair for training.

D Comparison Metrics

Throughout this work, we employ the relative L2 error as a metric to assess the test accuracy of each model, namely

$$Test error metric = \frac{{‖ {s}^{i} ( y ) - {\hat{s}}^{i} ( y ) ‖}_{2}^{2}}{{‖ {s}^{i} ( y ) ‖}_{2}^{2}} ,$$

where ŝ(y)the model predicted solution, s(y) the ground truth solution and i the realization index. The relative L₂ error is computed across all examples in the testing data-set, and different statistics of this error vector are calculated: the mean and standard deviation. For the Shallow Water Equations where we train on a lower resolution of the output domain, we compute the testing error using a full resolution grid.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features.

In particular, with reference to the appended claims, features from dependent claims may be combined with those of the independent claims and features from respective independent claims may be combined in any appropriate manner and not merely in the specific combinations enumerated in the appended claims.

What is claimed is:

1. A method for learning an operator mapping an input function to an output function, the method comprising:
mapping, by at least one processor, the input function to a feature vector;
determining, by the at least one processor, a first model for the operator by averaging the feature vector with a plurality of attention weights each corresponding to an output location of the output function; and
augmenting, by the at least one processor, the first model to learn the operator by coupling the attention weights together with an integral transform.

2. The method of claim 1, wherein each output location defines one or more probability distributions, and wherein determining the first model comprises averaging a plurality of rows of the feature vector over the probability distributions.

3. The method of claim 1, wherein coupling the attention weights together with an integral transform comprises coupling the attention weights together with a kernel integral operator.

4. The method of claim 1, wherein coupling the attention weights together with an integral transform comprises integrating a proposal score function against a coupling kernel.

5. The method of claim 1, wherein coupling the attention weights together with an integral transform comprises tuning one or more parameters of a coupling kernel.

6. The method of claim 1, wherein the input function or the output function or both are continuous functions.

7. The method of claim 1, wherein mapping the input function to a feature vector comprises using a wavelet scattering transform as a spectral encoder of the input function.

8. A system for learning an operator mapping an input function to an output function, the system comprising:
at least one processor and memory; and
an operator trainer implemented on the processor and configured for:
mapping the input function to a feature vector;
determining a first model for the operator by averaging the feature vector with a plurality of attention weights each corresponding to an output location of the output function; and
augmenting the first model to learn the operator by coupling the attention weights together with an integral transform.

9. The system of claim 8, wherein each output location defines one or more probability distributions, and wherein determining the first model comprises averaging a plurality of rows of the feature vector over the probability distributions.

10. The system of claim 8, wherein coupling the attention weights together with an integral transform comprises coupling the attention weights together with a kernel integral operator.

11. The system of claim 8, wherein coupling the attention weights together with an integral transform comprises integrating a proposal score function against a coupling kernel.

12. The system of claim 8, wherein coupling the attention weights together with an integral transform comprises tuning one or more parameters of a coupling kernel.

13. The system of claim 8, wherein the input function or the output function or both are continuous functions.

14. The system of claim 8, wherein mapping the input function to a feature vector comprises using a wavelet scattering transform as a spectral encoder of the input function.

15. One or more non-transitory computer readable media having stored thereon executable instructions that when executed by at least one processor of a computer cause the computer to perform steps comprising:
mapping the input function to a feature vector;
determining a first model for the operator by averaging the feature vector with a plurality of attention weights each corresponding to an output location of the output function; and
augmenting the first model to learn the operator by coupling the attention weights together with an integral transform.

16. The non-transitory computer readable media of claim 15, wherein each output location defines one or more probability distributions, and wherein determining the first model comprises averaging a plurality of rows of the feature vector over the probability distributions.

17. The non-transitory computer readable media of claim 15, wherein coupling the attention weights together with an integral transform comprises coupling the attention weights together with a kernel integral operator.

18. The non-transitory computer readable media of claim 15, wherein coupling the attention weights together with an integral transform comprises integrating a proposal score function against a coupling kernel.

19. The non-transitory computer readable media of claim 15, wherein coupling the attention weights together with an integral transform comprises tuning one or more parameters of a coupling kernel.

20. The non-transitory computer readable media of claim 15, wherein mapping the input function to a feature vector comprises using a wavelet scattering transform as a spectral encoder of the input function.
